(19) United States
(12) Patent Application Publication
(10) Pub. No.: US 2025/0315569 A1
(43) Pub. Date: Oct. 9, 2025

(54) FAST CONTINGENCY SIMULATION IN DYNAMIC MODELS OF POWER SYSTEMS

(71) Applicant: THE PENN STATE RESEARCH FOUNDATION, University Park, PA (US)

(72) Inventors: Nilanjan Ray CHAUDHURI, University Park, PA (US); Sina GHAREBAGHI, University Park, PA (US); Ting HE, University Park, PA (US); Thomas F. LA PORTA, University Park, PA (US)

(21) Appl. No.: 18/860,521

(22) PCT Filed: Apr. 25, 2023
(86) PCT No.: PCT/US2023/019835

§ 371 Date: Oct. 25, 2024

Related U.S. Application Data
(60) Provisional application No. 63/334,511, filed on Apr. 25, 2022.
(60) Provisional application No. 63/336,810, filed on Apr. 29, 2022.

(51) Int. Cl. G06F 30/20; G06F 113/04

(52) U.S. Cl. CPC G06F 30/20; G06F 2113/04

(57) ABSTRACT

A method for machine monitoring is disclosed. The method uses a fast time-domain cascading failure simulation approach based on implicit Backward Euler method (BEM) with stiff decay property. The method also exploits a predictor-corrector approach (PC-approach) to fully address the hyperstability issue in BEM, a dynamic model applying Trapezoidal method (TM) for numerical integration, and/or a center of inertia (COI) reference frame-based approach. Other aspects, embodiments, and features are also claimed and described.

### CROSS-REFERENCE TO RELATED APPLICATION(S)

This application claims the benefit of U.S. Provisional Patent Application Ser. Nos. 63/334,511 filed Apr. 25, 2022 and 63/336,810 filed Apr. 29, 2022, the disclosures of which are hereby incorporated by reference in their entirety, including all figures, tables, and drawings.

### STATEMENT OF GOVERNMENT SUPPORT

This invention was made in part with government support under Grant Number ECCS1836827 awarded by the National Science Foundation. The government has certain rights in the invention.

### TECHNICAL FIELD

The technology discussed below relates generally to power systems, more particularly, to contingency simulation in power systems.

### BACKGROUND

Continency planning for power system failures is an important task to ensure continuity and minimize down time. A contingency situation in a powers system environment implies failure of at least one component of the system. An example of contingency is a cascading failure, which may indicate that the failure of a component in an interconnected system can cause the failure of other components in the system. In highly complex dynamical systems like electric power grids, analyzing cascading failure is challenging as it demands long-term simulations of models involving solutions of many nonlinear differential and algebraic equations. As a result, it is very difficult to perform statistical analysis of cascading failure using such models. What are needed are systems and methods that address one or more of these shortcomings.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the disclosure, methods, systems, and/or apparatus for contingency analysis for offline planning and online operations is disclosed. As an example of contingency analysis, a method, a system, and/or an apparatus for cascading failure simulation and proactive ‘what-if’ analysis (e.g., (N−k) contingency analysis implying what happens when ‘k’ components are disabled or disconnected simultaneously from the system) to maintain secure operation of a power system is disclosed. For offline planning application, the disclosed invention can significantly speed up statistical ‘what-if’ analysis that is impractical with state-of-art. For ‘what-if’ analysis under online operational scenario (also known as Dynamic Security Assessment (DSA) in power systems domain), the disclosed invention significantly speeds up dynamic model-based contingency screening.

In further aspects of the disclosure, methods, systems, and/or apparatus for contingency detection and prevention in a power system is disclosed. The method, the system implementing the method, and/or the apparatus implementing the method may include running a simulation corresponding to the power system; obtaining, from the simulation, a plurality of power system component vectors at a plurality of corresponding times, a topology of the power system being altered at each of the plurality of times; solving a plurality of initial value problems with the plurality of power system component vectors for a time step using the simulation in parallel; obtaining a plurality of post-event unstable equilibrium points corresponding to the plurality of solved initial value problems; obtaining a system matrix based on the plurality of post-event unstable equilibrium points; identifying an earliest instability event and an instability time corresponding to the earlier instability event in the power system by decomposing the system matrix; identifying one or more original machines participating in the earliest instability event at the instability time based on participation factors; and scheduling a pre-determined protection action to the one or more original machines in the power system at the instability time.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1A is a flow chart of exemplary Backward Euler Method (BEM) with predictor-corrector (BEM-PC) approach according to some embodiments. FIG. 1B is a flow chart of exemplary a parallelized BEM-PC (BEM-PCP) approach according to some embodiments.

FIGS. 2A and 2B are illustrations of absolute stability regions of BEM in FIG. 2A and Trapezoidal Method (TM) in FIG. 2B according to some embodiments.

FIGS. 3A and 3B are illustrations of rotor angle time-domain plots in a single machine infinite bus (SMIB) system of BEM in FIG. 3A and TM in FIG. 3B according to some embodiments.

FIG. 4 is an illustration of an example of three different reference frames according to some embodiments.

FIG. 5 is an illustration of an example of island formation during cascading failure according to some embodiments.

FIG. 6 is an illustration of a fraction of cases with demand loss at the end of cascade for TM and BEM-PC in an IEEE 118-bus system according to some embodiments.

FIG. 7 is an illustration of a fraction of cases with line outage at the end of cascade for TM and BEM-PC in an IEEE 118-bus system according to some embodiments.

FIG. 8 is an illustration of a fraction of cases with demand loss at the end of cascade for TM and BEM-PC in a Polish system according to some embodiments.

FIG. 9 is an illustration of a fraction of cases with line outage at the end of cascade for TM and BEM-PC in a Polish system according to some embodiments.

FIGS. 10A and 10B are illustrations of demand loss vs number of branch and machine outage (FIG. 10A) and demand loss vs cascade sequence time for a Polish system (FIG. 10B) according to some embodiments.

FIG. 11 is an illustration of a timeline of number of branch outages and demand loss during cascade in a Polish system according to some embodiments.

FIG. 12 is a graph showing variation of speeds of G39 and G52 with oscillatory instability from beginning of cascade in an IEEE 118-bus system according to some embodiments.

FIG. 13 is an illustration of modeshapes estimated by BEM-PC corresponding to the unstable modes according to some embodiments.

FIG. 14 is graphs showing variation of speeds of G286 and G290 with oscillatory instability in the middle of cascade in a Polish system according to some embodiments.

FIG. 15 is an illustration of timelines of number of branch outages and demand loss during cascade in the oscillatory instability case according to some embodiments.

FIG. 16A shows modeshapes of generator speeds estimated by BEM-PC corresponding to the unstable interarea mode for a typical case with hyperstability issue in NE-NY system under the predictor subprocess in FIG. 3B. FIG. 16B shows one-line diagram of NE-NY test system highlighting SPS action.

FIG. 17 is a graph showing fraction of cases with % demand loss ≥x and outage ≥x at the end of cascade in NE-NY system: comparison between TM and BEM-PC.

FIG. 18 is a graph showing adaptation of integration time step Δt in TM and BEM-PC. Case (I) is presented in the top subplots while case (II) is presented in the bottom subplots.

FIG. 19 is Visualization of sparsity pattern of J22 in predisturbance condition, where nz shows number of nonzero elements. The matrix is 99.86% sparse.

FIG. 20 shows boxplots of runtimes of different subprocesses of BEM-PC during 500 MC runs of Polish system.

FIG. 21 shows boxplots of normalized runtime of TM and R-K w.r.t. BEM-PC for cascading failure in IEEE 118-bus system and polish system.

FIG. 22A is a graph shown a fraction of cases with % demand loss ≥x at the end of cascade in IEEE 118-bus system. FIG. 22B is a graph shown a fraction of cases with line outage ≥x at the end of cascade in IEEE 118-bus system.

FIG. 23A shows modeshapes of generator speeds corresponding to the most poorly-damped mode for 4th-order of NE-NY system under the predisturbance condition. FIG. 23B shows modeshapes of generator speeds corresponding to the most poorly-damped mode for classical models of NE-NY system under the predisturbance condition.

FIG. 24 is a graph shown a fraction of cases with % demand loss ≥x and line outage ≥x at the end of cascade in NE-NY system.

FIG. 25 is a graph shown a fraction of cases with % demand loss ≥x and line outage ≥x at the end of cascade in Polish system.

FIG. 26 is a flow chart illustrating an exemplary process for cascading failure detection and prevention in a power system according to some aspects of the disclosure.

FIG. 27 is a block diagram conceptually illustrating an example of a hardware implementation for the methods disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### I. INTRODUCTION

The ground truth following a contingency in power system can be obtained through a detailed dynamic model involving nonlinear differential and algebraic equations whose solution process is computationally expensive. This has prohibited adoption of such models for contingency analysis. As an example of contingency, we will consider cascading failure in power systems. To solve the problem, the present disclosure discloses a fast time-domain cascading failure simulation approach based on implicit Backward Euler method (BEM) with stiff decay property. Unfortunately, BEM may suffer from hyperstability issue in case of oscillatory instability and converge to the unstable equilibrium. The present disclosure proposes a predictor-corrector approach to fully address the hyperstability issue in BEM. The predictor may identify oscillatory instability based on eigendecomposition of the system matrix at the post-disturbance unstable equilibrium obtained as a byproduct of BEM. The corrector may use right eigenvectors to identify the group of machines participating in the unstable mode. This helps in applying appropriate protection schemes as in ground truth. The present disclosure may use Trapezoidal method (TM)-based simulation as the benchmark to validate the results of the disclosed approach on the IEEE 118-bus network, 2,383-bus Polish system, and IEEE 68-bus system. The disclosed approach is able to track the cascade path and replicate the end results of TM-based dynamic simulation with very high accuracy while significantly reducing the simulation time. The disclosed approach also produces comparable result as the partitioned method in a much shorter simulation time.

Since it is difficult to perform statistical analysis of cascading failure using dynamic system models, some applications may use less accurate but computationally manageable quasi-steady-state (QSS) models. The present disclosure may propose an approach for fast cascading failure simulation that accurately traces the cascade path and lends itself to statistical analyses.

In some examples, deterministic cascading failure analysis may be performed. The deterministic cascading failure analysis implicitly assumes that all systems act as expected during the cascade, i.e., potential mistripping of protective relaying and other malfunctions are not considered during the cascade. This may be different from probabilistic approaches that consider that the evolution of the power system after an initial set of contingencies can follow multiple trajectories.

Unlike the QSS models, some dynamic models of cascading failure may be broadly divided into three categories. 1) Review—& proposition-type models: For example, some modeling techniques and simulation frameworks for cascading failure analysis may involve interaction between protection systems and cascading failure. Other dynamic power system simulator may have the ability to tune the present direct linear solver, nonlinear solver, and the DAE integrator. In the same line, a parallelized algorithm may be used for cascade simulations. The focus is to increase the simulation speed through parallel strategy intended for deployment on the supercomputer. 2) Hybrid cascading failure models: A cascading failure simulation tool called dynamic contingency analysis tool (DCAT) may employ a hybrid approach of simulation that judges the stress of the system and switches between QSS and dynamic simulations. In addition to standard relay modeling, some models may consider misoperations like stuck breakers and corrective actions in post-transient steady-state conditions. 3) Dynamic cascading failure models: A two-level probabilistic risk assessment of cascading outages may be used. Dynamic cascade events are separated into two categories, slow and fast cascade. The modeling may combine probabilistic simulations for the slow and the fast cascading events using different degree of details in the dynamic models.

A detailed dynamic model for deterministic cascade propagation analysis can be exploited. The method can be tested with randomly selected N−2 contingencies. The load model may be desirable in evaluating the risk of cascading failures. The DC QSS model can reasonably approximate the cascade path in the early stages and deviate from the ground truth in later stages. A multi-time period two-stage stochastic mixed-integer linear optimization model can be utilized to specify the optimal investment on the network to enhance system's resilience against natural disasters. The model may use dynamic simulations for cascading failure simulation, and the multi-time period restoration, modeled through a DC optimal power flow initialized by the solution of dynamic simulation.

The first category of models either reviewed the state-of-art or made propositions, but no cascading failure simulations were performed in these works. The second and the third categories of models may still suffer from the computational burden faced by the simulation of dynamic models. For example, 88 cases were simulated in Polish system out of 1,200 that can be called cascades because most (1,081) did not have a dependent outage leading to short simulations, while 31 diverged. Hybrid simulation strategy can reduce simulation time but may face accuracy issues as it is complicated to switch between dynamic and QSS simulations. At any rate, analysis starts with dynamic simulations—hence the bottleneck remains.

The reason behind this is the fact that these dynamic simulations use a similar structure and the same integration methods as in the conventional planning models. The objective of traditional planning studies is to perform N−1 and N−2 contingency simulations that normally last up to 30 s. They are computationally very expensive and not suitable for running cascading failure simulations.

The present disclosure proposes a fast time-domain cascading failure simulation approach based on implicit Backward Euler method (BEM) with stiff decay property, in which large time-step can be used to speed up simulations. However, one disadvantage of BEM is the hyperstability issue in case of oscillatory instability that leads to convergence to the unstable equilibrium. The present disclosure proposes a predictor-corrector approach (PC-approach) to fully address the hyperstability issue in BEM. The disclosed dynamic model may trace the exact cascade path during simulation and reproduce the exact end result of cascade with respect to the ground truth. The present disclosure may use a dynamic model, which applies Trapezoidal method (TM) for numerical integration as a benchmark to test the disclosed model for cascade simulations. Also, this is the first time a center of inertia (COI) reference frame-based approach has been disclosed for cascading failure simulation leading to island formation. This can be called an adaptive COI frame method. Results on the IEEE 118-bus system, IEEE 68-bus system, and the 2,383-bus Polish network show high accuracy and significant speedup in simulation with multi-tier cascading failures. In addition, the disclosed approach maintains a significant speedup gain compared to the partitioned approach with an explicit numerical integration method.

The structure of dynamic simulation methods used for power system planning is disclosed. Then, the challenges in using them for power system cascading failure simulation is elaborated.

### A. Dynamic Simulation Preliminaries

Power system's dynamic model is typically represented by a set of nonlinear differential algebraic equations (DAEs). The differential equations can be represented in the following compact form,

$$\dot{x} = f ( x , V , z ) , \qquad Equation ( 1 )$$

$$0 = I ( x , V , z ) - {Y}_{N} ( z ) V , \qquad Equation ( 2 )$$

$$0 > h ( x , V , z ) . \qquad Equation ( 3 ) ,$$

where, x∈ [symbol] ⁿ is the state vector consisting of individual device states, and V∈ [symbol] ^{m} denotes the vector of real and imaginary components of bus voltages, [symbol] ∈P is a discrete variable whose elements can assume values 0 or 1 indicating status of circuit breakers operated by relays, I∈ [symbol] ^{m} constitutes of real and imaginary components of current injection phasors in buses, and Y_{N}∈ [symbol] ^{m×m} is the admittance matrix of network in its real form (i.e., separating the real and imaginary parts of the equations), and h: [symbol] ⁿ× [symbol] ^{m}× [symbol] ^{p}→ [symbol] ^{q} indicates line currents can be below their ratings and bus voltages below corresponding thresholds, among others. If the inequality constraint Equation (3) is violated, the relevant relay will determine the trip time Tₜᵣᵢₚ and start a countdown process. When Tₜᵣᵢₚ becomes zero, the corresponding element of z, whose nominal value is 1, also becomes 0. This changes the Y_{bus} and/or the injected current I. If the inequality constraint violation no longer holds before Tₜᵣᵢₚ goes to zero, the countdown stops. The details of different types of relay actions have been included in Section IV.

Dynamic simulation in power system solves an initial value problem (IVP) on the DAEs (i.e., Equation (1) and Equation (2)) with a set of known initial conditions (x₀, V₀, z₀)∈ [symbol] ⁿ× [symbol] ^{m}× [symbol] ^{q}. For a cascading failure simulation, such IVPs are solved repeatedly following each event, where an event refers to a discontinuity introduced by fault, line tripping, load shedding, and so on. The exemplary method in the present disclosure for solving the IVPs in power systems may be partially based on a simultaneous method.

### B. Simultaneous Solution

Here, some examples of the simultaneous approach are described using an implicit integration method, TM. In the context of solving DAEs described in the previous section, z is an implicit variable and does not appear explicitly in the numerical integration process, except that it brings in discontinuities. To avoid clutter, going forward z can be dropped from equations and will describe how discontinuities are handled later. Discretization of Equation (1) using TM results in the following expression,

$$F ( {x}_{n + 1} , {V}_{n + 1} ) = {x}_{n + 1} - {x}_{n} - Δ t / 2 ( f ( {x}_{n + 1} , {V}_{n + 1} ) + f ( {x}_{n} , {V}_{n} ) ) , \qquad Equation ( 4 )$$

where, Δt is the step-size of integration, subscript n corresponds to time instant tₙ,
and F is the mismatch function for differential equations. The mismatch function for algebraic equations is defined as follows,

$$G ( {x}_{n + 1} , {V}_{n + 1} ) = {Y}_{N} {V}_{n + 1} - I ( {x}_{n + 1} , {V}_{n + 1} ) , \qquad Equation ( 5 )$$

where, xₙ₊₁ and Vₙ₊₁ are found by simultaneously solving the following nonlinear algebraic equations,

$$F ( {x}_{n + 1} , {V}_{n + 1} ) = 0 , G ( {x}_{n + 1} , {V}_{n + 1} ) = 0. \qquad Equation ( 6 )$$

Typically, Newton's method is used for solving these equations. For the (k+1)^{th} iteration of Newton's method, Equation (7) is as follows,

$$[ \begin{matrix}{x}_{n + 1}^{k + 1} \\ {V}_{n + 1}^{k + 1}\end{matrix} ] = [ \begin{matrix}{x}_{n + 1}^{k} \\ {V}_{n + 1}^{k}\end{matrix} ] + [ \begin{matrix}Δ {x}_{n + 1}^{k} \\ Δ {V}_{n + 1}^{k}\end{matrix} ] , \qquad Equation ( 7 )$$

$$[ \begin{matrix}- F ( {x}_{n + 1}^{k} , {V}_{n + 1}^{k} ) \\ - G ( {x}_{n + 1}^{k} , {V}_{n + 1}^{k} )\end{matrix} ] = {[ \begin{matrix}\frac{\partial F}{\partial {x}_{n + 1}} & \frac{\partial F}{\partial {V}_{n + 1}} \\ \frac{\partial G}{\partial {x}_{n + 1}} & \frac{\partial G}{\partial {V}_{n + 1}}\end{matrix} ]}_{n + 1}^{k} [ \begin{matrix}Δ {x}_{n + 1}^{k} \\ Δ {V}_{n + 1}^{k}\end{matrix} ] , \qquad Equation ( 8 )$$

$$[ J ] = {[ \begin{matrix}\frac{\partial F}{\partial {x}_{n + 1}} & \frac{\partial F}{\partial {V}_{n + 1}} \\ \frac{\partial G}{\partial {x}_{n + 1}} & \frac{\partial G}{\partial {V}_{n + 1}}\end{matrix} ]}_{n + 1}^{k} = [ \begin{matrix}{J}_{11} & {J}_{12} \\ {J}_{21} & {J}_{22}\end{matrix} ] , \qquad Equation ( 9 )$$

where, J is the Jacobian matrix. First, Δx and ΔV are calculated using Equation (8), which in turn may be used to update x and V through Equation (7). Newton iterations are stopped when [F^{T} G^{T}]^{T}∥_{∞}≤ϵ, where ϵ∈ [symbol] ⁺ is the tolerance for convergence.

### Remarks on the Examples

1. Variants of Newton iterations: Three example variants are full Newton's method, dishonest/very dishonest Newton's method (VDHN), and quasi-Newton method.
2. Jacobian calculation: Both direct analytical method and difference approximation method may be used.
3. Solution of linear equation Ax=b: Since the Jacobian is very sparse, solving the set of linear Equations (8) in the general form Ax=b may take significant advantage of this aspect during storage and computations. Both direct solution methods like sparsity-oriented triangular factorization and KLU, and iterative solutions like Preconditioned Conjugate Gradient (PCG), and General Minimal Residual (GMRES) method may be used.
4. Variable time-step: To speed up the simulation, adaptive time step size control is used based on local truncation error (LTE) that may lead to large time steps when solution is not varying rapidly.
5. Suitability for cascading failure simulation: Even applying sparse computations for solving Equation (8) and using a variable time-step TM-based solver, the some examples may suffer from significant computational burden during cascading failure simulation, since they take much longer than typical N−1 or N−2 contingency simulations that last 30 s or less.
6. Handling discrete events: If the integration time step Δt calculated by the variable-step algorithm is more than the time remaining before Tₜᵣᵢₚ becomes zero, then Δt is truncated to match the tripping instant. When Tₜᵣᵢₚ becomes zero, at t=tₙ, a discrete event occurs due to relay action, i.e., certain elements of z become 0. In this case, the following steps are performed—(a) network configuration is updated and the corresponding Y_{bus} is calculated; (b) Vₙ is updated by iteratively solving Equation (5) for t=tₙ. To that end, Y_{N} is updated if needed and the J₂₂ sub-matrix of the Jacobian in Equation (9) is used. Next, updated xₙ and Vₙ are used as the initial guess for t=tₙ₊₁, i.e., [(xₙ₊₁⁰)^{T} (Vₙ₊₁⁰)^{T}]^{T}=[(xₙ)^{T} (Vₙ)^{T}]^{T} can be used. Equation (8) is then iteratively solved to find [xₙ₊₁^{T} Vₙ₊₁^{T}]^{T}; (c) the time-step is reduced to the minimum step-size of Δtₘᵢₙ for a pre-defined period of simulation; (d) the IVPs based on the predicted initial conditions are solved using the reduced time-step.

Going forward, ‘ground truth’ can be defined as the cascading failure simulation results produced by a benchmark model that uses (a) variable-step TM with Δt∈[0.002, 1]s, ϵ=10⁻⁴ that leverages an adaptive COI reference frame-based approach described below, (b) formulates the Jacobian analytically, (c) applies full Newton iterations, (d) uses sparse objects for storage and calculations, and (e) applies Matlab's most comprehensive inversion routine for solving Equation (8). The model consists of 4^{th}-order synchronous generator model equipped with the same governors, static exciters, and relays as an exemplary model described below, except that the special protection scheme (SPS) is not functional, but measurement-based. The benchmark and the exemplary models are built from the first principles in Matlab, and MATPOWER is used for power flow solution used during initialization. Simulation may be stopped if i) the speed variation of machines in a predetermined window length is below a certain threshold, and ii) no future relay actions are anticipated, or iii) a complete collapse is observed.

### III. EXEMPLARY METHODOLOGY FOR DYNAMIC SIMULATION OF CASCADING FAILURE

At the outset, what is expected out of a dynamic cascading failure simulation model can be defined. 1) The model may be able to capture the exact cascade propagation path as in ground truth. 2) The model may give exact end-result of cascade as the ground truth in terms of topology, voltage profile, frequency, and demand served. 3) The model may be computationally efficient, so that statistical analyses can be performed, which is critical for cascading failure studies.

Even though it would be ideal if the dynamic model is able to simulate the exact trajectories of state and algebraic variables of the system as the ground truth and also lends itself to statistical analyses—unfortunately, that has proven to be elusive thus far. If the above objectives are met at the expense of accurate tracking of trajectories of system variables, it can be sufficient for dynamic cascading simulations without compromising accuracy of statistical analyses.

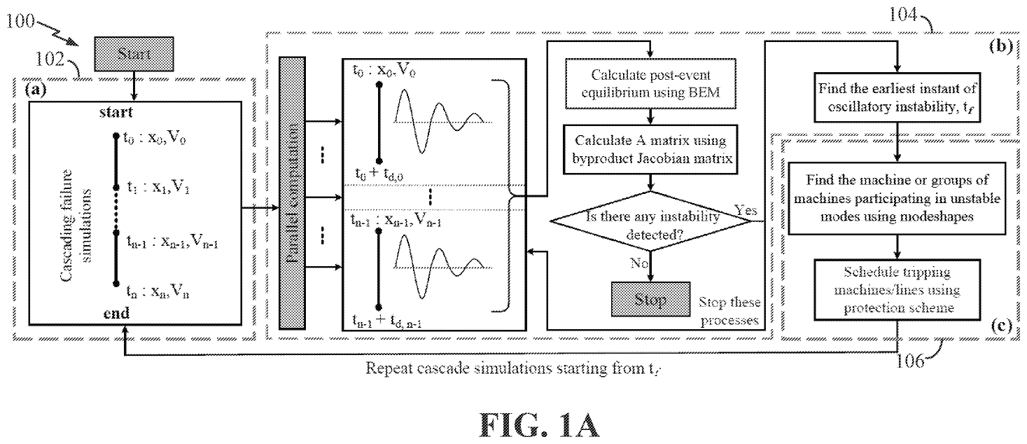

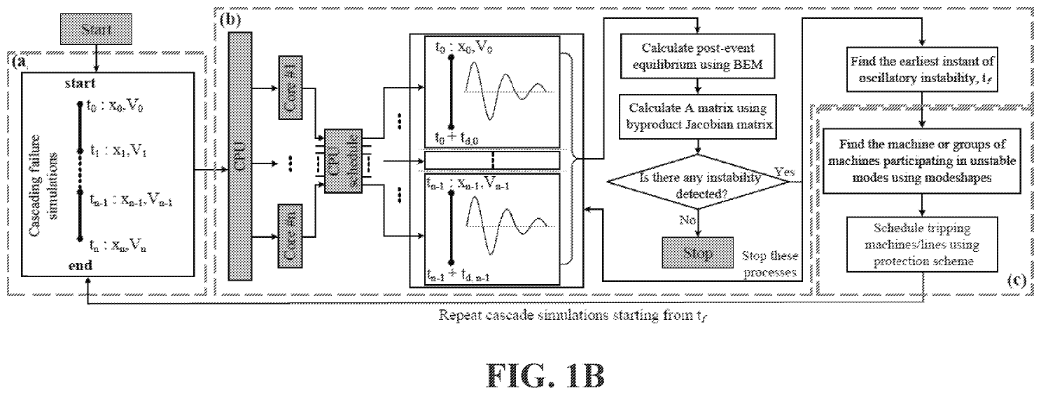

To that end, the exemplary methods are shown in FIGS. 1A and 1B. FIG. 1A shows a flowchart 100 of an example BEM with predictor-corrector (BEM-PC) approach while FIG. 1B shows a flowchart of a parallelized version of BEM-PC approach. Processes that can be run using parallel processors are indicated (e.g., as shown in FIG. 1). FIGS. 1A and 1B may include cascading failure simulation subprocesses 102, predictor subprocess 104, and corrector subprocess 106. Section III below explains the flowchart further in detail. FIG. 1A shows a simplified time-domain simulation approach based on a stiff decay integration method. More specific, the inventors apply implicit backward Euler method (BEM) for the simultaneous solution process. The disclosure solves the hyperstability issue of BEM using an eigen analysis-based predictor-corrector method, which leverages its stiff-decay and hyperstability properties. FIG. 1B is similar to processes in FIG. 1A. However, the processes in FIG. 1B provides a parallelized version of BEM-PC (BEM-PCP) to achieve a simulation speedup. In BEM-PCP, the predictor subprocess of BEM-PC is run in multiple parallel processors for identification of oscillatory instability using eigen-decomposition of the system matrix at post-disturbance unstable equilibria. Also, the disclosure proposes functional implementation of SPS against unstable inter-area oscillations and generator non-first swing out-of-step protection (e.g., due to an unstable local mode). The inventors model time-delayed overcurrent (OC), local undervoltage load shedding (UVLS), and generator first swing out-of-step relays. In some embodiments, other types of relays can also be modeled in the disclosed framework. This disclosure provides an adaptive COI frame-based approach that can seamlessly perform during island formation.

### A. BEM. Absolute Stability and Stiff Decay Properties

BEM may be derived using a Taylor expansion centered at tₙ₊₁, which is first-order accurate and normally sufficient for an efficient computation. Discretizing Equation (1) using BEM results in the following expression:

$$F ( {x}_{n + 1} , {V}_{n + 1} ) = {x}_{n + 1} - {x}_{n} - Δ tf ( {x}_{n + 1} , {V}_{n + 1} ) . \qquad Equation ( 10 )$$

1) Absolute stability property: First, the absolute stability property of TM can be analyzed, and this can be compared with that of BEM. The standard approach for this is to consider the so-called test equation \dot{x}=λx, where λ is a complex number denoting the eigenvalue of a system matrix. The region of absolute stability is defined as the region in the complex λΔt-plane such that applying the numerical integration method for the test equation from within this region yields an approximate solution satisfying the absolute stability requirement |xₙ₊₁|≤|xₙ|. By discretizing the test equation using TM, the equation is as follows:

$${x}_{n + 1} = \frac{2 + λ Δ t}{2 - λ Δ t} {x}_{n} ; AF = \frac{2 + λ Δ t}{2 - λ Δ t} , \qquad Equation ( 11 )$$

where, AF is called amplification factor. Therefore, the region of absolute stability of TM can be obtained by the region that is satisfying AF≤1, which is the left half of the λΔt plane. Similarly, applying BEM to the test equation results in:

$${x}_{n + 1} = \frac{1}{1 - λ Δ t} {x}_{n} ; AF = \frac{1}{1 - λ Δ t} . \qquad Equation ( 12 )$$

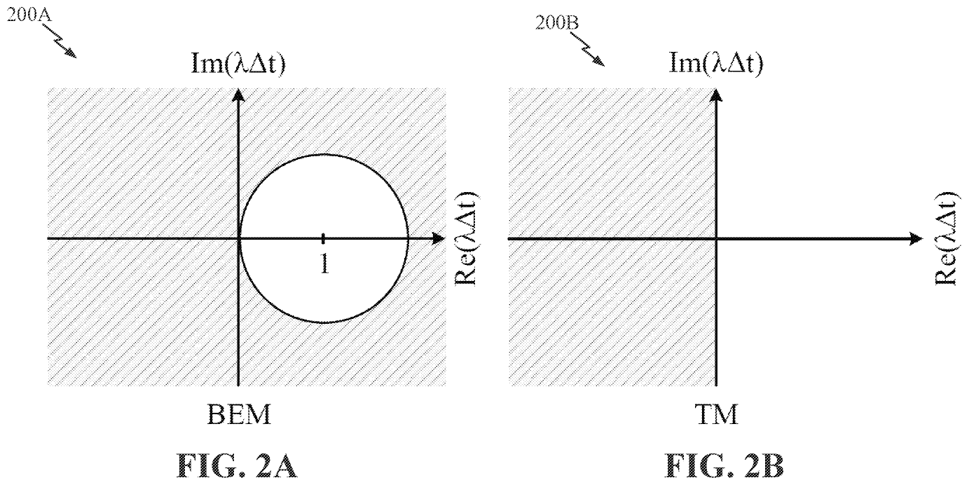

Therefore, the region of absolute stability of BEM is the entire left half of the λΔt plane in addition to the entire right half plane outside the unit circle centered at (1, 0). FIGS. 2A and 2B shows absolute stability regions of BEM 200A in FIG. 2A and TM 200B in FIG. 2B shown in gray. As shown in FIGS. 2A and 2B, the regions of absolute stability in gray indicates that both TM and BEM are numerically A-stable.
2) Stiff decay property: In line with the example presented earlier, in the dynamic simulation of cascading failure, one might not be interested in detailed transient oscillatory behavior of the system as long as the expectations are met. In this regard, using large time steps would be desired. However, the integration method should be robust enough to tolerate the large steps. When

$$( λΔ t ) \to - ∞ for BEM \frac{1}{1 - λ Δ t} \to 0$$

may be used, however, for

$$T M \frac{2 + λ Δ t}{2 - λ Δ t} \to - 1.$$

This property in BEM is called stiff decay, representing ability of BEM in taking large steps to ignore fast oscillations in the dynamic model. On the other hand, one should not expect TM to act like integral methods with stiff decay property. This is due to the fact that the fast mode components of local errors for large time steps get propagated throughout the simulation interval.
3) Hyperstability issue of BEM: It is clear that the stiff decay property of BEM can be used to the advantage for dynamic simulations of cascading failure as it helps us take large time steps for ignoring fast oscillations and obtaining a coarse picture of the desired trajectories. However, BEM is never used in dynamic simulations of power system due to the hyperstability problem.

When a numerical integration method solves the differential equations of an unstable system and produces a stable response, then, such a problem is called Hyperstability. This can be viewed from the absolute stability region of FIG. 2 satisfying [symbol] (λΔt)>0 and ( [symbol] (λΔt)−1)²+( [symbol] (λΔt))²>1. It corresponds to the right half plane outside the unit circle of the left subfigure. The practical implication of this is that BEM is not able to diagnose oscillatory instability if λΔt lies in this region.

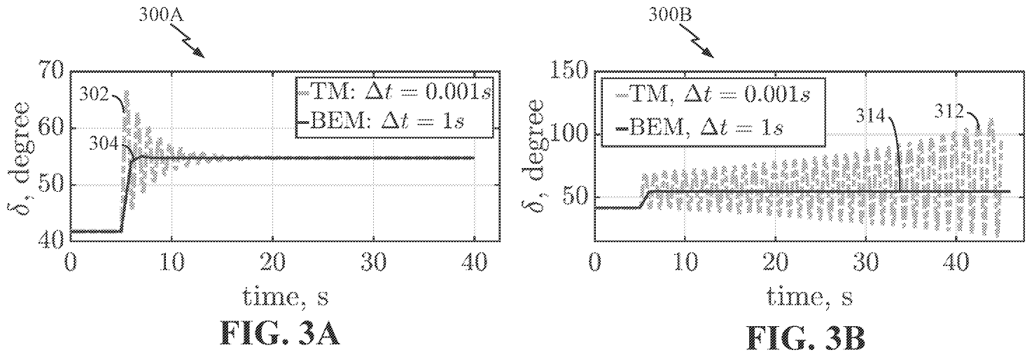

FIGS. 3A and 3B compares the performance of BEM and TM in a single machine (represented by classical model) infinite bus (SMIB) system after tripping one of the double-circuit lines at t=5 s. The left 300A (FIG. 3A) and the right subplots 300B (FIG. 3B) represent a stable and an unstable case, respectively—the latter is simulated by a negative damping factor. In both the scenarios, traditional model with TM (302 in FIG. 3A and 312 in FIG. 3B) is simulated with Δt=0.001 s, and BEM (304 in FIG. 3A and 314 in FIG. 3B) uses much larger time step of is. It can be seen that for the stable case, the stiff decay property allows BEM to obtain the exact final result as TM while producing a coarse trajectory. For the unstable case however, the hyperstability problem of BEM is evident, where it converges to the unstable equilibrium point. Next, this disclosure addresses the hyperstability problem of BEM in detail.

### B. Addressing Hyperstability Problem of BEM Using Predictor-Corrector Approach

The present disclosure proposes a predictor-corrector (PC) approach to tackle the hyperstability problem in BEM, which is shown in a flowchart in FIG. 1. In this flow chart, there are four key functions that are being performed in a serial-parallel process.
1) Cascading Failure Simulation Subprocesses (a): In this subprocess 102, the cascading failure simulation using variable-step BEM can be run, where OC, UVLS, and generator first swing out-of-step relays are modeled. The stopping criterion for BEM is similar to TM as described earlier. i.e., simulation is stopped if i) speed variation of machines in a predetermined window length is below a certain threshold and no future relay actions are anticipated, or ii) a complete collapse is observed. For step-size control in BEM, the inventors use a different method than TM,

$$Δ {t}_{n + 1} = Δ {t}_{n} \frac{τ}{{‖ {F}_{x}^{0} ‖}_{∞}} ; Δ {t}_{k} ∈ [ Δ {t}_{min} , Δ {t}_{max} ] , \qquad Equation ( 13 )$$

where, ∥Fₓ⁰∥_{∞} shows the largest component of the first mismatch vector and τ is a hyperparameter to be tuned. Immediately following each event, simulation with Δt=0.002 s can be run for a pre-determined k steps. This ensures that the non-oscillatory instability is captured. Moreover, if Newton iterations takes more than r iterations for convergence at a time instant, then time-step can be decreased to Δt=0.002 s.

During the course of such a simulation, the instants of tiers (events that alter the topology of the system) of cascade are marked by time variable t=tᵢ in FIG. 1. Corresponding to each such instant, the values of x and V as [tᵢ:xᵢ, Vᵢ] may be obtained. In some examples, this subprocess runs in a serial manner to solve a sequence of IVPs described in above.

Following each such instant, there could be four broad types of unstable scenarios so far as voltage, angle, and frequency stability are concerned—(1) local voltage instability, (2) frequency instability, (3) non-oscillatory angle instability, and (4) local/inter-area oscillatory angle instability. Except the last phenomena, BEM does not face issues in capturing the others.

As discussed earlier, due to the hyperstability issue, BEM may converge to the unstable equilibrium following the fourth category of instability. This in turn can deviate the cascade propagation path from ground truth. The present disclosure may identify the earliest tier of onset of such instability, and execute appropriate protective actions that will be taken in the ground truth.
2) Predictor subprocess (b): This subprocess 104 shown in FIG. 1 runs after subprocess 102 (a) ends. It may constitute running multiple simulations and calculations that are independent and thus parallelizable. The following steps are taken—
i. Solving independent IVPs for short duration: As subprocess (a) spits out [tᵢ:xᵢ, Vᵢ] data, IVPs can be solved with initial values (xᵢ, Vᵢ) that can be run in the ith parallel processor using variable-step BEM for t_{d,i} when BEM's stopping criterion is met. The simulation for the ith independent IVP is stopped if the speed variation of machines in a predetermined window length is below a certain threshold. As shown in FIG. 1, t_{d,i} is the time elapsed since the beginning of such a simulation when this stopping criterion is met. In this period, any event including relay actions may not be considered.
ii. Calculate system matrix for model linearized around post-event equilibrium: Solving variable-step BEM within each parallel processor allows the trajectories to reach the post-event equilibrium—the post-event unstable equilibrium point due to BEM's stiff-decay and hyperstability properties. The system matrix (A matrix) of the model linearized around this equilibrium may be calculated as a byproduct of BEM-based simulation using the elements of the Jacobian matrix as follows

$$A = {P}_{11} + {P}_{11} {P}_{22}^{- 1} {P}_{21} , \qquad Equation ( 13 )$$

$$where ,$$

$${P}_{11} = \frac{1}{Δ t} ( I - {J}_{11} ) ; {P}_{12} = - \frac{1}{Δ t} {J}_{12} ; {P}_{21} = - {J}_{21} ; {P}_{22} = {J}_{22} \qquad Equation ( 14 )$$

where, I denotes the identity matrix and Δt is the time step at the end of duration t_{di}.
iii. Eigendecomposition of A matrix: Eigendecomposition of A matrix is performed to detect oscillatory instability. For large systems, one can use selective unstable eigenvalue and corresponding right eigenvector calculations using the S-method. The earliest event and corresponding time instant, say t_{f} is identified at which the instability occurs.
3) Corrector Subprocess (c): If any oscillatory instability is detected, its origin can be found from participation factors. Assuming the typical case of instability from electromechanical modes, the machine or groups of machines participating in these modes can be found in subprocess 106 (c) using their speed modeshapes calculated in subprocess 104 (b). Functional implementation of the predetermined protection action (e.g. out-of-step generator tripping or SPS action) can be scheduled. For example, a predetermined protection action can be set to trigger in a subject, real-world system, based on output of the processes and simulations described herein. Thus, in some embodiments, a simulation system can output an identification to a user (or directly to a subject system, automatically) of a specific protective action that should be taken upon a given set of circumstances and/or cause that protective action to occur in the subject system when the set of circumstances is detected. The predetermined protection action will take place following t=t_{f} in the ground truth after a designed delay.
4) Restart subprocess (a): As shown in FIG. 1, with the knowledge of pre-determined protection action to be taken, the solution of IVPs can be reinitiated at t=t_{f} with initial states xⱼ, V_{f} and perform protection actions after a pre-defined delay and continue solving the subsequent IVPs.

The above steps will be repeated until no instability is detected in the predictor subprocess.

### C. Discussion on Computational Efficiency of BEM-PC

In this Section, a brief qualitative discussion is presented on the computational efficiency of BEM-PC compared to TM using logical arguments. Since it is difficult to analytically quantify this advantage, the inventors have performed exhaustive comparison between the disclosed method and TM through statistical analysis of CPU time needed for different subprocesses within BEM-PC in Section V-C.

The exemplary logical argument relies on the following points:
1) Subprocess (a) in FIG. 1 runs with variable time algorithm (13), which allows significantly larger step size Δt compared to that allowed in LTE-based variable step TM mentioned before. This is possible due to the stiff-decay property of BEM as described in III-A. As a result, this subprocess can run much faster than TM. The inventors have presented a statistical analysis of CPU time for running this subprocess compared to TM in Section V-C. In addition, the inventors have also shown variation of time-step Δt for TM and BEM in a few typical cases.
2) Subprocess (b) is parallelizable. It has three main tasks: (b1) Calculation of the post-event equilibrium, (b2) Calculation of A matrix from Equation (14), and (b3) Eigendecomposition (i.e., calculation of eigenvalues and modeshapes) of A matrix. The first part can be performed extremely fast with large Δt. The A matrix calculation is a by-product and needs inversion of J₂₂, which is a highly sparse matrix. The inventors leverage sparse computation for this. Also, there are highly efficient routines for eigendecomposition. Further, in some examples, once any unstable mode is found, A matrix does not need to be calculated for the remaining equilibria. The inventors have demonstrated statistical analysis of CPU time needed for these individual steps in Section V-C without parallelization.
3) Subprocess (c) needs minimal computation as it is based on lookup table for enacting SPS action.
4) Clearly, the computational efficiency of BEM relies on the fact that for a typical power system, a relatively small fraction of cascade simulations will lead to oscillatory instability, and therefore needs to re-run subprocess (a).

The results in Section V-C support the above-mentioned arguments. In addition, a comparison with partitioned approach with fixed time-step-based explicit integration leads to similar conclusions. At a fundamental level, the disclosed approach will be able to speed up any transient stability simulation of power systems with accurate end results. However, due to short-term nature of typical transient stability simulations the speed gain would be rather limited. In contrast, cascading failure simulations may run for a much longer time, lead to formation of multiple islands, and show response across different time-scales throughout the process. BEM can run with a larger integration time-step than TM during most of the simulation period, which makes it ideally suited for longer term simulations. This argument becomes even more relevant since the disclosed BEM-PC approach requires additional computations due to the prediction and the correction steps.

### D. BEM-PC-Parallel (BEM-PCP)

The present disclosure proposes a parallelized version of BEM-PC (BEM-PCP) to achieve a simulation speedup. In BEM-PCP, the predictor subprocess of BEM-PC is run in multiple parallel processors for identification of oscillatory instability using eigen-decomposition of the system matrix at post-disturbance unstable equilibria. Monte-Carlo studies on a 2,383-bus Polish system confirm that BEM-PCP is on average 17% faster than BEM-PC and ≈40 times as fast as TM while maintaining the same accuracy as BEM-PC.

FIG. 1B shows the flowchart of BEM-PCP approach, where parallelized predictor-corrector is proposed to: 1) overcome the hyperstability issue of BEM, and 2) speedup the predictor subprocess of BEM-PC.

Subprocess (a)—Cascading failures simulation: In this subprocess, cascade simulations run using variable-step BEM in a serial manner. The cascading failure is triggered with initial bus outages and tripping connected lines to those buses at to. Following each event, IVP(s) are solved with known initial condition (x₀, V₀,z₀) for each island. Appropriate relays such as out-of-step machine protection, overcurrent (OC) relays, and undervoltage load shedding (UVLS) relays are modeled in the cascade simulations. Simulations in subprocess (a) are stopped if i) steady state is reached in the time-domain simulation with no expected relay action, or ii) the island under consideration collapses.

Subprocess (b)—Parallelized predictor: This subprocess starts after cascading simulations in subprocess (a). For each post-event island that is posed as an independent IVP, it is desirable to be verified that there is no oscillatory instability. Due to the independent nature of these IVPs, they can be solved in parallel to speedup simulations. Therefore, each IVP with corresponding known initial condition is assigned to a parallel core. Simulations are run using variable-step BEM for suitable periods t_{d,i}s to reach the stable or unstable equilibrium points.

Relay actions that imply a discrete change in the simulations are inhibited. Once the equilibrium is reached, the system matrix (A-matrix) of the linearized model around the equilibrium is calculated using Jacobian matrix which is a by-product of BEM simulations.

For each post-event island, the eigenvalues of the A matrix can be inspected for any inter-area/local oscillatory unstable mode particularly for the earliest instant of oscillatory instability (t_{f}) among all events, since results after that instant are inaccurate and have to be corrected.

Subprocess (c)—Corrector: If any oscillatory instability is detected in subprocess (b), machines or group of machines that are participating in the unstable mode can be identified by investigating right eigenvectors of speeds of machines that are calculated in subprocess (b). Next, appropriate pre-specified special protection scheme (SPS) as in the ground truth is applied. Runtime of subprocess (c) in BEM-PCP can be negligible.

After SPS commands are executed, we repeat simulations in subprocess (a) from t_{f}, and re-apply subprocesses (b) and (c) for events after t_{f}. The sequence of subprocesses in FIG. 1B can be stopped once no oscillatory instability is detected.

Machine model: In some examples, a detailed 4th-order machine model with E_{q}′, E_{d}′, δ, Δw states can be integrated with static exciter and a first-order governor model with E_{fd} and Pₘ states in BEM-PCP and all benchmarks.

Relay model: All models include identical UVLS relays for tripping loads in buses with voltages below a threshold vₜₕ with delay T_{delay}^{UVLS}, OC relays for tripping overloaded lines with delay T_{delay}^{OC}, generators out-of-step protection, and pre-specified functional SPS actions for protections against oscillatory instability modes with trip delay T_{delay}^{SPS}.

Adaptive COI-frame: Instead of using Real-Imaginary network frame rotating at synchronous speed, in each island we project all phasors on Center-of-Inertial (COI)-reference frame rotating with

$${w}_{coi} = \frac{1}{{\sum }_{i ∈ M} {H}_{i}} {\sum }_{i ∈ M} {H}_{i} {w}_{i}$$

speed, where ωᵢ and Hᵢ are the rotor speed and inertia constant of the ith machine. M refers to set of all machines in the island. COI-frame will add two additional states δ_{COI} and Δω_{COI} to each island. For more details, such as appropriate initializations of states including speed and angle of COI-frame. Adaptive COI-frame can be identically applied to BEM-PCP and other models.

Structure of cascade model: Since TM does not suffer from hyperstability, it only runs subprocess (a) in FIG. 1B. However, it is desirable for BEM-PCP to run the whole process in FIG. 1B iteratively until no oscillatory instability is detected. Although BEM-PCP runs subprocesses (b), and (c) in addition to subprocess (a) that TM runs, it uses much larger step-sizes than TM due to stiff decay property, which makes BEM-PCP much faster than TM.

### IV. MODELING AND ADAPTIVE COI-FRAME-BASED APPROACH

### A. Component and Relay Action Models

A 4th-order synchronous generator model (states E′_{q}, E′_{d}, δ, Δω) can be considered with a first-order governor and static exciter models. Both static constant power and dynamic loads in the form of synchronous condensers were considered. The synchronous condensers have similar models as generators, except that they do not have governors.

In some scenarios, certain relay actions may be considered in our model. For example, undervoltage load shedding (UVLS) relays are associated with individual buses connected to static loads, measuring an average voltage magnitude in a window of length T_{w}^{UVLS}. The relay trips λ fraction of load if the average voltage magnitude of bus stays below threshold Vₜₕ for T_{w}^{UVLS}. The maximum number of times of UVLS relays are allowed to shed a specific load is Kₘₐₓ^{shed}.

The overcurrent (OC) relays measure an average magnitude of current flow in the lines in a T_{w}^{OC} window. The trip delay for an overloaded line is

$${T}_{tp}^{line} = \frac{0.14}{{( \frac{\vert I \vert}{{I}_{C}} )}^{0.02} - 1}$$

where, |I|, and I_{c} are average current flow in the present window and line heating limit, respectively. The window for OC relays is updated once in every second. Due to probable large amplitude oscillations in the line flows immediately following an event, OC relays use the latest pre-event trip delays till 1 s following the event and then starts updating it. In addition, generator out-of-step relay action trips a machine with non-oscillatory instability. In some scenarios, a specific type of pre-designed SPS action on oscillatory instability involving multiple machines may be considered as described in Section V-B. For both TM and BEM-PC, if the time remaining till the earliest scheduled trip instant by relays, Δₜᵣᵢₚ^{relay} is less than Δtₙ₊₁ suggested by variable-step algorithms, Δtₙ₊₁=Δtₜᵣᵢₚ^{relay}. Both BEM-PC and TM solve IVPs of the same DAEs, but the former can reach the post-disturbance equilibrium faster. This is possible because BEM-PC has stiff decay property that enables it to use a variable integration time-step with a larger step-size than TM during most of the simulation period. In certain cases, the cascading process may include mid/long term stability issues involving aspects like boiler dynamics and long-term frequency instability. This however can easily be integrated in the disclosed framework, and is not a limitation. Due to its stiff-decay property, BEM is ideally suited for longer term simulations and gives more benefit.

### B. Adaptive COI-Frame-Based Approach

In both TM and BEM-PC approaches, instead of network reference frame 402 (R−I frame) rotating at synchronous speed wₛ 404, all phasors of an island on the COI frame 410 (d_{coi}−q_{coi}) rotating can be projected at

$${w}_{coi} = \frac{1}{{H}_{T}} {\sum }_{i ∈ M} {H}_{i} {w}_{i} ,$$

where wᵢ 408 and Hᵢ are the rotor speed and inertia constant of the ith machine,

$${H}_{T} = {\sum }_{i ∈ M} {H}_{i} ,$$

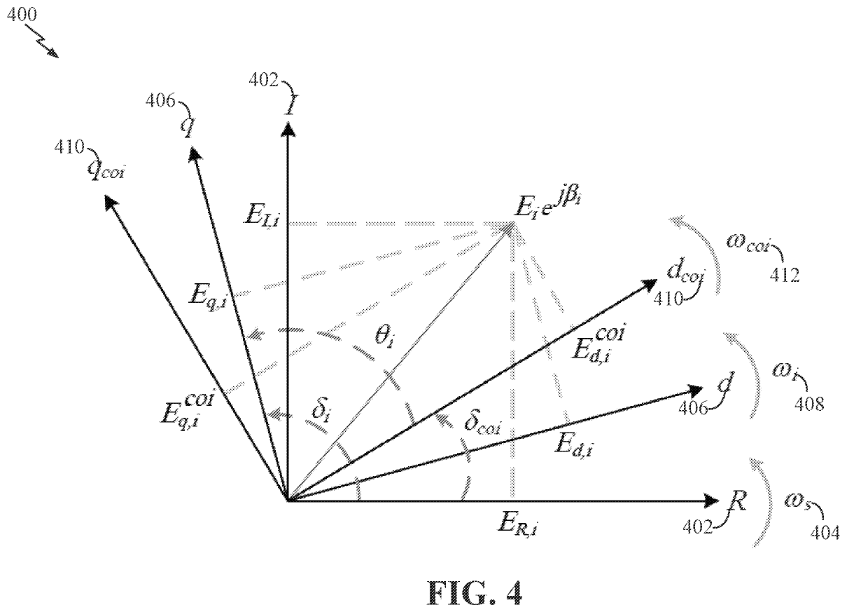

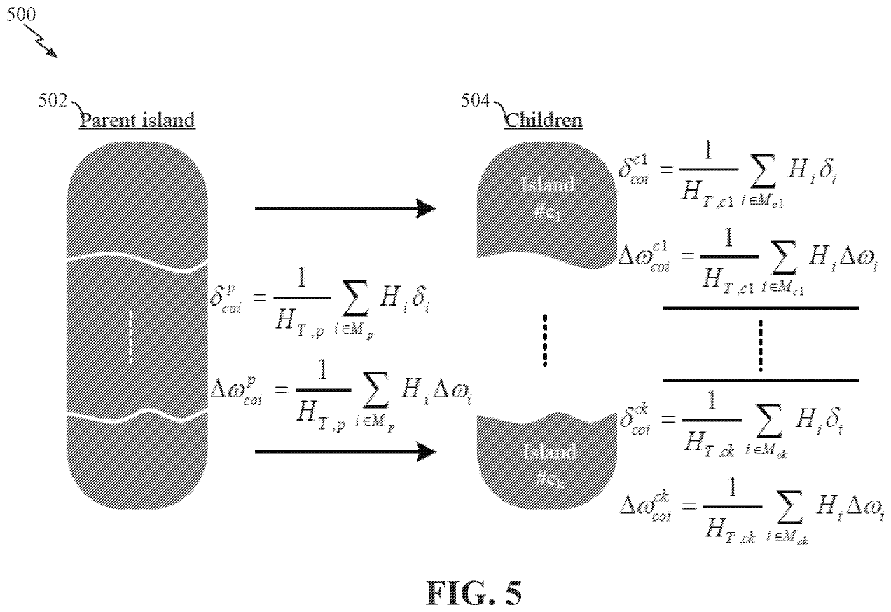

and M is the set of indices indicating machine numbers in the corresponding island. FIG. 4 shows the terminal voltage phasor of the ith machine projected on different reference frames including the machine's own d-q frame 406. The use of COI frame leads to rotor angle θᵢ=δᵢ−δ_{coi} (where,

$${δ}_{c o i} = \frac{1}{{H}_{T}} {\sum }_{i ∈ M} {H}_{i} {δ}_{i} ) ,$$

which is constant in steady state under off-nominal frequency. This helps in efficient convergence of Newton iterations in Equation (7), which is common knowledge. What is challenging however, is adapting this framework for a cascading scenario that leads to formation of multiple children 504 from a parent island 502, see FIG. 5.

Challenge during formation of multiple islands: Let t=tₙ be the last instant when the parent island was intact and t=tₙ₊₁ be the first post-islanding instant from children 504 as in FIG. 5. In some examples, dynamic states xₙ can be used to predict xₙ₊₁ for both TM Equation (3) and BEM-PC Equation (9), and in addition Vₙ is required for TM. Since Mₚ≠M_{ci}∀ᵢ, see FIG. 5, the converged xₙ values corresponding to the pre-islanding instant cannot be used. To be more specific, the challenge comes from the fact that unlike the R-I frame 402 which can be applied for any island, the COI frames are locally applicable to individual islands (FIG. 5). To solve this problem, the current disclosure proposes an adaptive COI frame-based approach, which is described next.

Disclosed approach: The following steps can be performed to calculate [xₙ₊₁^{T} Tₙ₊₁^{T}]^{T} within any child island #ci.

Step (I): Since R-I frame 402 is universal, δₙ, Δwₙ∈ [symbol] ^{|M}^{_{ci}}^{|} may be calculated as

$${δ}_{n} = {θ}_{n} + {δ}_{COI \_ n}^{p} Δ {w}_{n} = Δ {\overline{w}}_{n} + Δ {\overline{w}}_{COI \_ n}^{p} \qquad Equation ( 15 )$$

where, θₙ, Δw̅ₙ∈ [symbol] ^{|M}^{_{ci}}^{|} are rotor angle and speed deviation vectors in island #ci w.r.t. the parent's COI frame.

Step (II): This is the step where the COI frames are adaptively changed from parent 502 to child 504 for each island. To that end, θₙ, Δw̅ₙ∈ [symbol] ^{6|M}^{_{ci}}^{|} can be updated from the parent's COI frame to the COI frame of island #ci (FIG. 5) as

$${θ}_{n}^{ct} = {δ}_{n} - {δ}_{COI \_ n}^{ci} Δ {\overline{w}}_{n}^{ci} = Δ {w}_{n} - Δ {w}_{COI \_ n}^{ci} \qquad Equation ( 16 )$$

$$where , {δ}_{COI \_ n}^{ci} = \frac{1}{{H}_{T , c i}} {\sum }_{i ∈ M} {H}_{i} {δ}_{i n} and Δ {w}_{COI \_ n}^{ci} = \frac{1}{{H}_{T , c i}} {\sum }_{i ∈ M} {H}_{i} Δ {w}_{i n} .$$

In some scenarios, the other machine states, exciter states, and governor states are not changed. The device states along with δ_{COI_n}^{ci} and Δw_{COI_n}^{ci} constitute the updated state vector xₙ∈ [symbol] ^{6|M}^{_{ci}}^{|+2} for island #ci.

Step (III): Vₙ within island #ci can be updated by iteratively solving (4) for t=tₙ with updated states xₙ from Step (II). To that end, Y_{N} can be updated if needed and make use of the J₂₂ sub-matrix of the Jacobian in Equation (8).

Step (IV): In the final step, updated xₙ and Vₙ can be used as the initial guess for t=tₙ₊₁, i.e., [(xₙ₊₁⁰)^{T} (Vₙ₊₁⁰)^{T}]^{T}=[(xₙ)^{T} (Vₙ)^{T}]^{T} can be used. Equation (7) can be iteratively solved to find [xₙ₊₁^{T} Tₙ₊₁^{T}]^{T} in island #ci.

In some embodiments, steps (II) and (III) constitute a sequential approach within the simultaneous solution process. For t>tₙ₊₁, the adaptive COI-frame based approach may be identical with standard COI-based approach in the island's own COI frame until it further breaks into multiple islands.

### V. EXAMPLES

The IEEE 118-bus system and the Polish network during winter 1999-2000 peak condition are studied here to contrast the exemplary approach (called BEM-PC hereafter) and the traditional approach (called TM from now). The IEEE 68-bus system is also studied, which will be introduced later. The IEEE 118-bus system consists of 118 buses, 54 machines, and 186 branches. The Polish system is a large-scale network with 2,383 buses, 327 machines, and 2,896 lines. Dynamic data can be synthetically generated for these models. For the IEEE 118-bus and the Polish systems, cascades are triggered with 2 and initial node outages, respectively, which are sufficient to create long term cascading sequences in these networks. For each case, 500 Monte-Carlo runs were performed with random selection of initial node outages. For BEM-PC, Δtₘᵢₙ=0.02 s, Δtₘₐₓ=0.4 s, k=6, r=7, E=10⁻⁴ can be used, and maximum allowable Newton iterations is 10. For relays, T_{w}^{UVLS}=3 s, Tₜₚ^{UVLS}=3 s, λ=25% vₜₕ=0.8645. pu for IEEE 118-bus system, and 0.75 pu for Polish system, Kₘₐₓ^{shed}=5, and T_{w}^{OC}=1 s have been used.

In some scenarios, the following results implement the Predictor subprocesses 104 (b) of BEM-PC in FIG. 1 in a serial fashion. For IEEE 118-bus system, the simulations were run in AMD Ryzen 7 3800X CPU with 32 GB RAM and for Polish system 4 servers with 2.2 GHz Intel Xeon Processor, 24 CPU/server, and 128 GB RAM in PSU's ROAR facility were used.

### A. Monte-Carlo Simulation

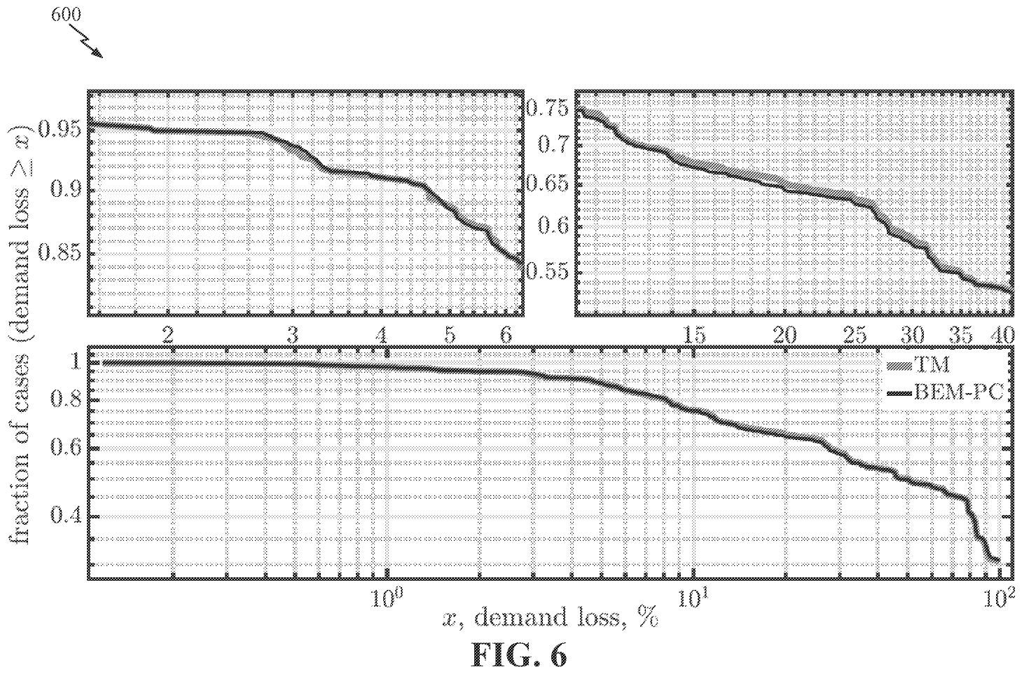

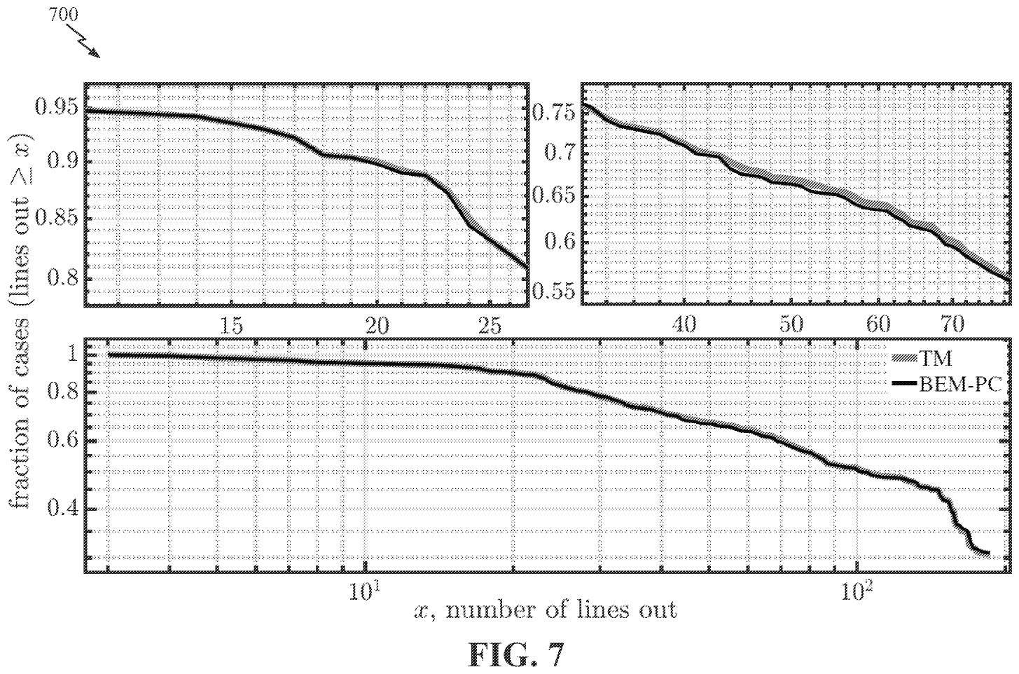

IEEE 118-Bus System: FIGS. 6 and 7 compare how often the total demand loss and line outages at the end of cascade are above a particular level for TM and BEM-PC. FIG. 6 shows fraction of cases 600 with % demand loss ≥x at the end of cascade in an IEEE 118-bus system, where x shows different levels of percentages of demand loss that can vary from 0% to 100%. FIG. 7 shows fraction of cases 700 with line outage ≥x at the end of cascade in an IEEE 118-bus system. The analysis includes initial node outages. The top two zoomed subplots of indicate that there are small differences between BEM-PC and TM for cases with (15%-25%) demand loss and cases with (44-60) line outages. Nonetheless, the results indicate a very close match between the end results of cascade.

Table I compares the accuracy of BEM-PC with respect to TM and shows that the average error at the end of cascade in states (connected vs disconnected) of buses, machines, and lines are 0.54%, 0.54%, and 0.48%, respectively of the corresponding total numbers. Similarly, the central tendency measures of maximum errors in voltage magnitudes, angles, and frequency are very small. Although there are some outliers causing an increase in the average error values, for almost all of the cases BEM-PC is able to replicate the exact end-result of TM.

TABLE I
(a) End of cascade error, (b) path agreement measure, and
(c) run time in TM w.r.t. BEM-PC: IEEE 118-Bus System

| | | mean | min | max | median |
|---|---|---|---|---|---|
| error in | buses | 0.6460 | 0 | 77 | 0 |
| state of | machines | 0.2940 | 0 | 36 | 0 |
| | lines | 0.8960 | 0 | 114 | 0 |
| maximum | \|v\|, pu | 0.0024 | 0 | 0.0741 | 7.9 × 10⁻⁷ |
| error in | <v, deg. | 0.2874 | 0 | 14.5731 | 0.0001 |
| | f, H z | 0.0442 | 0 | 2.3127 | 1.1 × 10⁻⁶ |

| | | | | |
|---|---|---|---|---|
| R | 0.9911 | 0.25 | 1 | 1 |
| Runtime ratio | 9.9575 | 0.3403 | 60.4361 | 9.0554 |

The R values in Table I show path agreement measure between BEM-PC and TM based on dependent branch outages, where both models are subject to the same set of initial outages C={c₁, c₂, . . . }. If contingency cᵢ results in the set of Aᵢ dependent line outages in the first model and the set of Bᵢ dependent line outages in the second model, then R is defined as follows,

$$R = \frac{1}{\vert C \vert} {\sum }_{i = 1}^{\vert C \vert} \frac{\vert {A}_{i} ∩ {B}_{i} \vert}{\vert {A}_{i} ⋃ {B}_{i} \vert} \qquad Equation ( 17 )$$

where, R=1 indicates a complete match between cascade paths from two models following all contingencies.

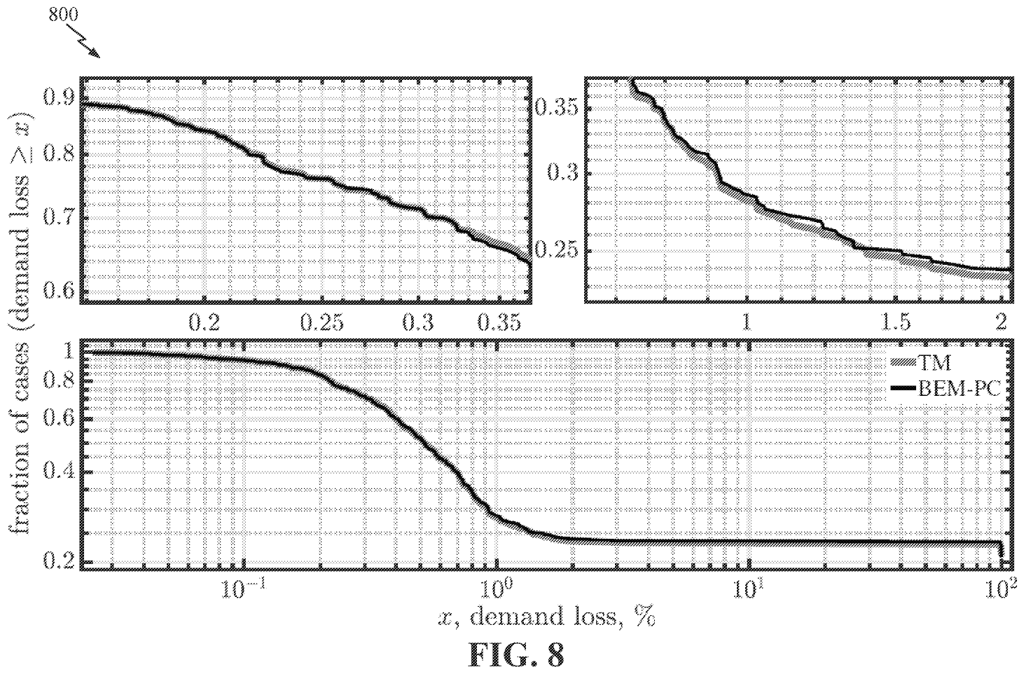

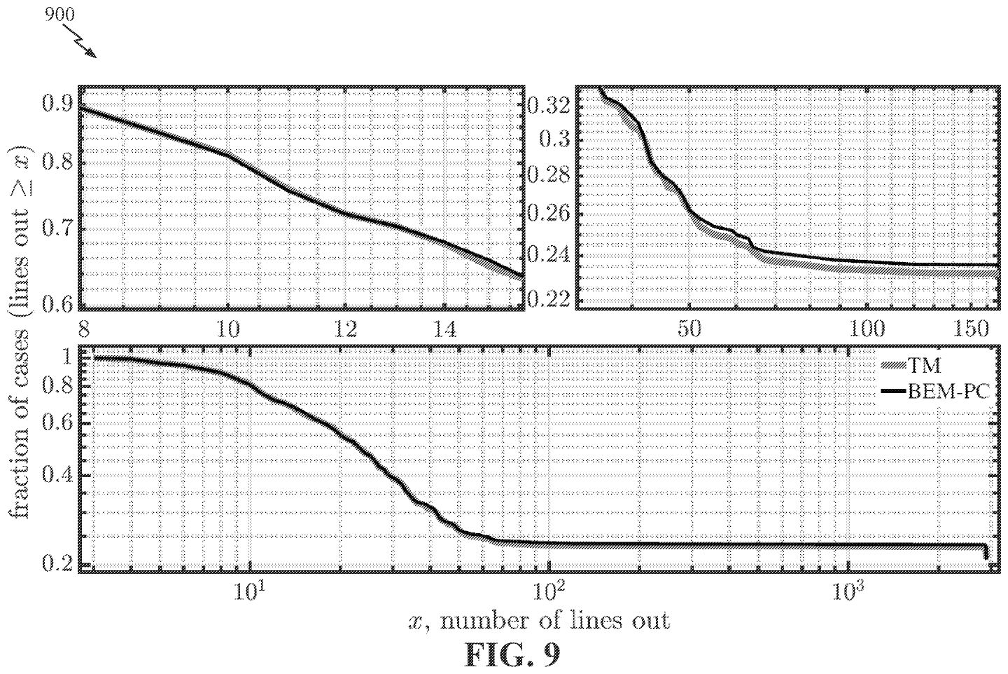

Based on the central tendency measures of R from Table I and its standard deviation being 0.05916, the inventors conclude that the models have a high agreement in the cascade path. In addition to the high accuracy of BEM-PC in most of Monte-Carlo runs on average it is approximately 10 times faster than TM.
2) Polish System: As before, FIGS. 8 and 9 compare how often the total demand loss and line outages at the end of cascade are above a particular level for TM and BEM-PC—a very close match is observed. FIG. 8 shows fraction of cases 800 with % demand loss ≥x at the end of cascade in a Polish system. FIG. 9 shows fraction of cases 900 with line outage ≥x at the end of cascade in a Polish system.

TABLE II
(a) End of cascade error, (b) path agreement measure,
and (c) run time in TM w.r.t. BEM-PC: Polish System

| | | mean | min | max | median |
|---|---|---|---|---|---|
| error in | buses | 0.1220 | 0 | 8 | 0 |
| state of | machines | 0.0620 | 0 | 4 | 0 |
| | lines | 0.1600 | 0 | 7 | 0 |
| maximum | \|v\|, pu | 0.0008 | 0 | 0.0360 | 2.1 × 10⁻⁵ |
| error in | <v, deg. | 0.1441 | 0 | 10.1075 | 0.0004 |
| | f, H z | 0.0165 | 0 | 0.2414 | 8.4 × 10⁻⁵ |

| | | | | |
|---|---|---|---|---|
| R | 0.9922 | 0.75 | 1 | 1 |
| Runtime ratio | 34.6097 | 1.1593 | 430.3984 | 24.7959 |

Table II compares various error measures at the end of cascade for BEM-PC with respect to TM. These indicate that for almost all of the cases, BEM-PC is able to accurately mimic the end results of cascade as in TM. The central tendency measures of R from Table II and its standard deviation equaling 0.03230 demonstrate that the models have a high degree of agreement in the cascade path. Finally, runtime ratio indicates that on average the disclosed model is 34.6 times faster than the standard model.

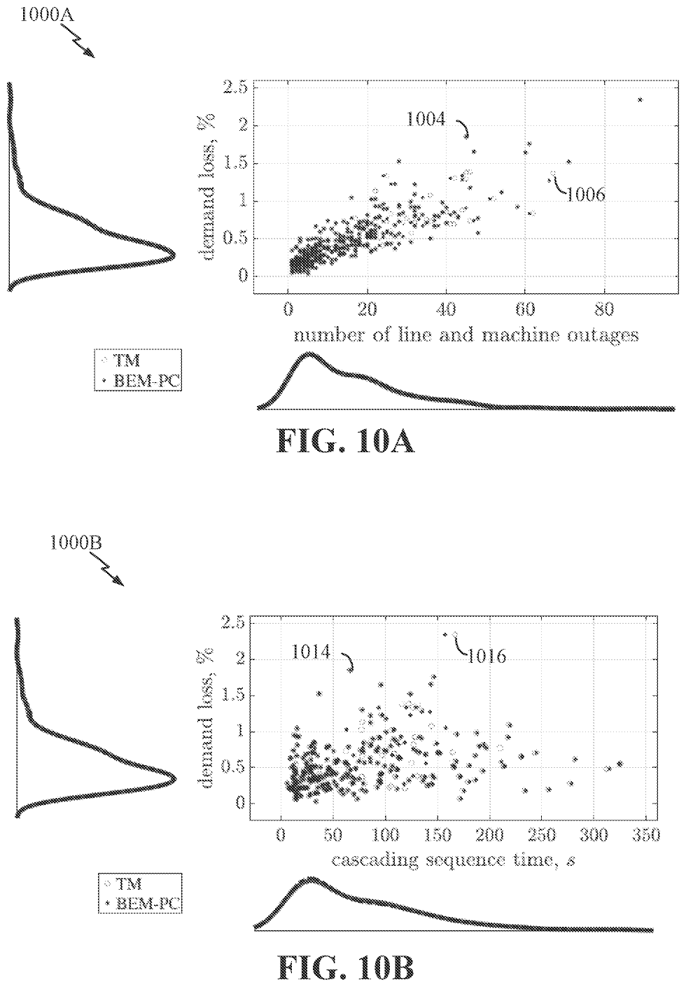

FIGS. 10A and 10B provides comparison between BEM-PC and TM on correlation of various end-of-cascade measures like demand loss vs number of outages in FIG. 10A and demand loss vs cascade sequence time (time between initial and final event) in FIG. 10B. Out of 500 Monte-Carlo runs with 3 initial node outages, 41 cases are resilient cases and did not lead to any dependent events after initial node outages, whereas 118 cases did not converge and were considered as collapsed cases. In both panels in this figure, cases without dependent events and cases with complete collapse are disregarded. Following are the observations:
Both plots indicate that the correlations among the two pairs of variables in BEM-PC 1006, 1016 closely match that of TM. However, there are a few cases in which these two approaches produce slightly different results.
The density curves reveal almost identical distribution patterns for TM 1004, 1014 and BEM-PC 1006, 1016 for both sets of values on x and y axes.
The right panel indicates a considerable number of cases have cascade sequence time more than 100 s.

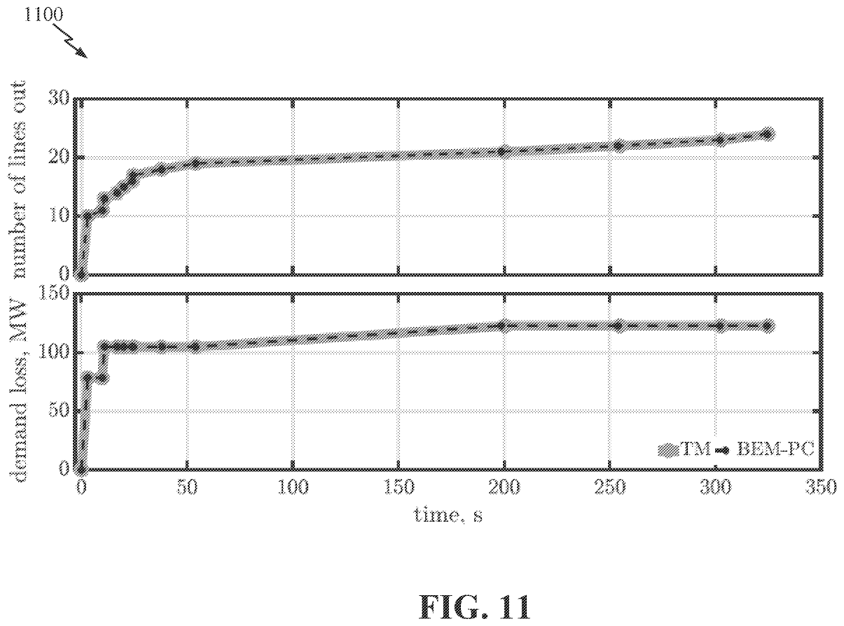

For a sample case in the Polish system, time-domain plots representing the number of branch outages and demand loss against time are shown in FIG. 11. The nodes in the figure indicate the instants of outage/demand loss. The plots reveal that BEM-PC is following the exact cascade path as in the ground truth. Also, it is worth noting that the disclosed simulation approach is 28 times faster than TM in this case. As described earlier, initially (at t=3 s) 3 random nodes are disconnected to trigger cascade. These initial node outages are therefore not dependent outages, i.e., they do not represent the severity of cascade. In FIG. 11, the initial node outage caused disconnection of 10 lines at t=3 s in addition to significant demand loss.

### B. Hyperstability A Challenge for BEM and Performance of Predictor-Corrector Approach

In this section, accuracy of our disclosed BEM-PC approach is tested against different cases with oscillatory instability in both IEEE 118-bus system and the Polish network. To that end, the inventors create two oscillatory instability situations in the system by making damping coefficient negative in some machines, first at the beginning of cascade (case #1), and in a separate case somewhere in the middle of cascade (case #2).

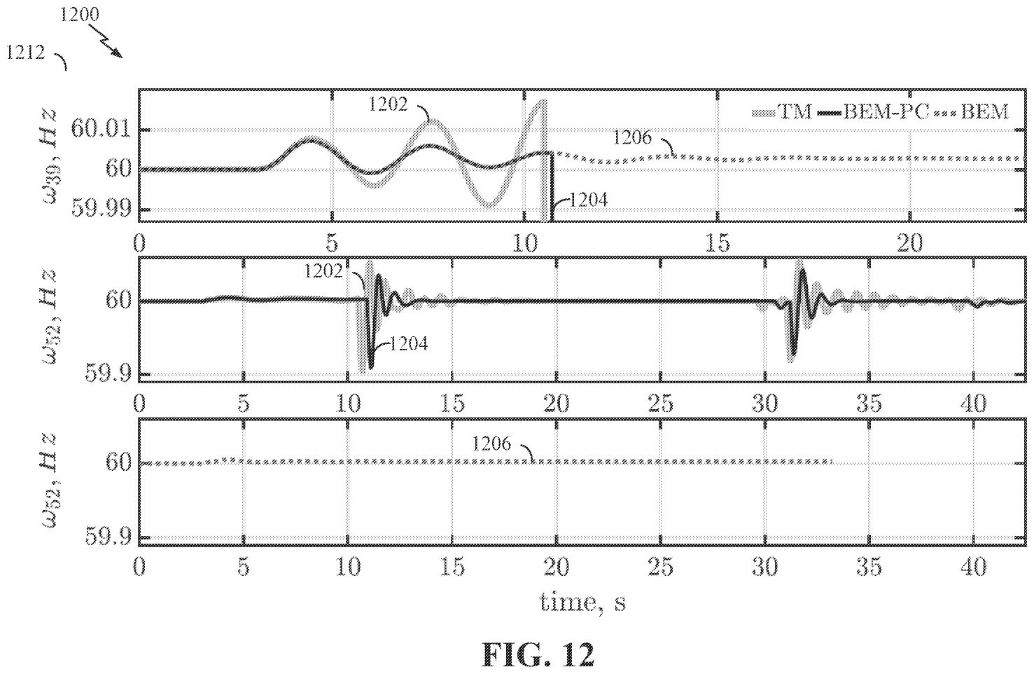

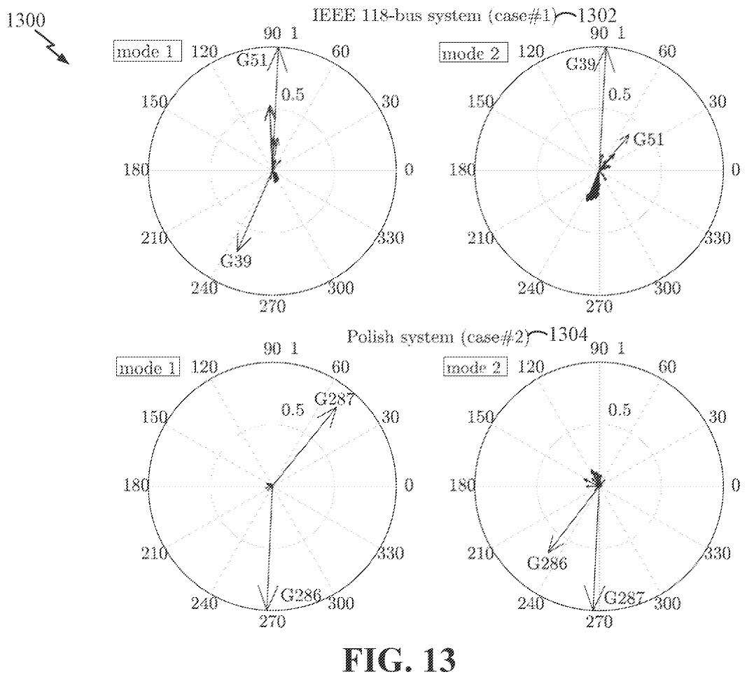

The SPS action is designed to trip two unstable machines with the highest amplitudes of oscillations upon detection of oscillatory instability. In TM this takes place through explicit SPS action after 7.5 s and 4.5 s, respectively, in IEEE 118-bus and Polish system. However, in BEM-PC, a functional implementation is achieved by identifying the unstable mode and participating machines using eigendecomposition of the A matrix for post-event equilibrium as shown in FIG. 1. Then, the suitable predetermined protection action is taken by SPS. In some scenarios, other type of SPS actions can also be taken like tripping certain lines to disconnect areas oscillating against each other.
1) IEEE 118-Bus System: The inventors make the damping coefficients of generators G39 and G51 negative. For case #2, the inventors introduce the negative values at the start of third tier in the middle of cascade. FIG. 12 shows rotor speeds of two representative machines in case #1 for TM 1202, BEM-PC 1204, and BEM 1206 without PC-approach (BEM). The top and bottom subplots show that BEM leads to only one tier of cascade due to hyperstability issue. The top panels show that BEM-PC has captured the oscillatory instability in the system and is able to tackle the hyperstability issue of BEM-PC note slight difference in tripping times in BEM-PC due to the OC relays' window-based averaging described in Section IV. The estimated unstable modes by BEM-PC are 0.1239±j2.4889 and 0.1121±j2.0531 and the corresponding estimated modeshapes are shown in FIG. 13. Based on the modeshapes, G51 and G39 are tripped after a 7.5 s delay. Eventually, TM and BEM-PC lead to 25 tiers of cascade (not shown here). In FIG. 13, mode shares are estimated by BEM-PC corresponding to the unstable modes for case #1 1302 in IEEE 118-bus and for case #2 1304 in Polish system under the corrector subprocess 106 (c) in FIG. 1.

Tables III and IV compare path agreement and various end-of-cascade measures for these three models in cases #1 and #2. Clearly, BEM-PC solved the hyperstability issue of BEM, had identical cascade propagation path, and replicated the end results of cascade in the ground truth in much shorter time. As expected, BEM without PC approach shows significantly different results than the ground truth.

TABLE III
End-of-cascade comparison: IEEE 118-Bus System

| | | demand | lines | mach. | cascade | runtime |
|---|---|---|---|---|---|---|
| | | loss, % | out | out | time, s | ratio |
| Case | TM | 83.415 | 157 | 44 | 146.93 | 7.72 |
| #1 | BEM-PC | 83.415 | 157 | 44 | 146.23 | 1 |
| | BEM | 1.060 | 4 | 0 | 3 | 0.09 |
| Case | TM | 7.013 | 31 | 6 | 337.11 | 5.29 |
| #2 | BEM-PC | 7.013 | 31 | 6 | 336.78 | 1 |
| | BEM | 1.885 | 9 | 0 | 69.88 | 0.27 |

TABLE IV
End-of-cascade and path agreement comparison: IEEE 118- bus System

| | | error in state of | | | max error in | | | |
|---|---|---|---|---|---|---|---|---|
| | TM vs | buses | mach. | lines | \|v\|, pu | <v, deg. | f, Hz | R |
| Case | BEM-PC | 0 | 0 | 0 | 7.8 × 10⁻⁷ | 0.0002 | 1.8 × 10⁻⁴ | 1 |
| #1 | BEM | 93 | 44 | 153 | 9.7 × 10⁻² | 13.5892 | 4.0900 | 0.159 |
| Case | BEM-PC | 0 | 0 | 0 | 5.8 × 10⁻⁶ | 0.0064 | 5.3 × 10⁻⁵ | 1 |
| #2 | BEM | 6 | 6 | 22 | 9.7 × 10⁻² | 15.6320 | 1.4 × 10⁻⁴ | 0.875 |

### C. Polish System

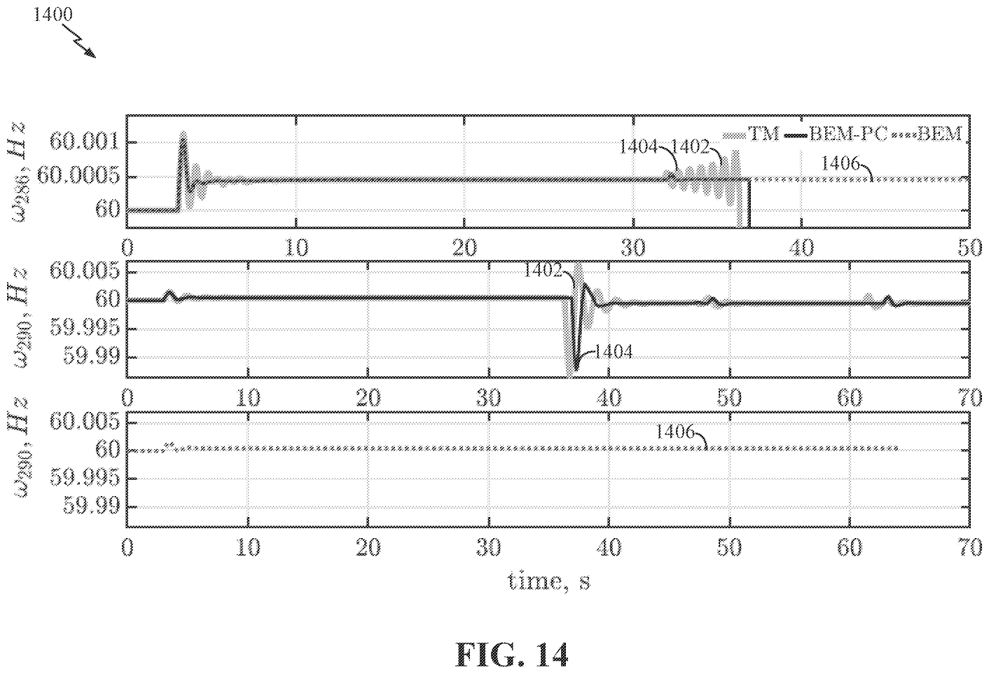

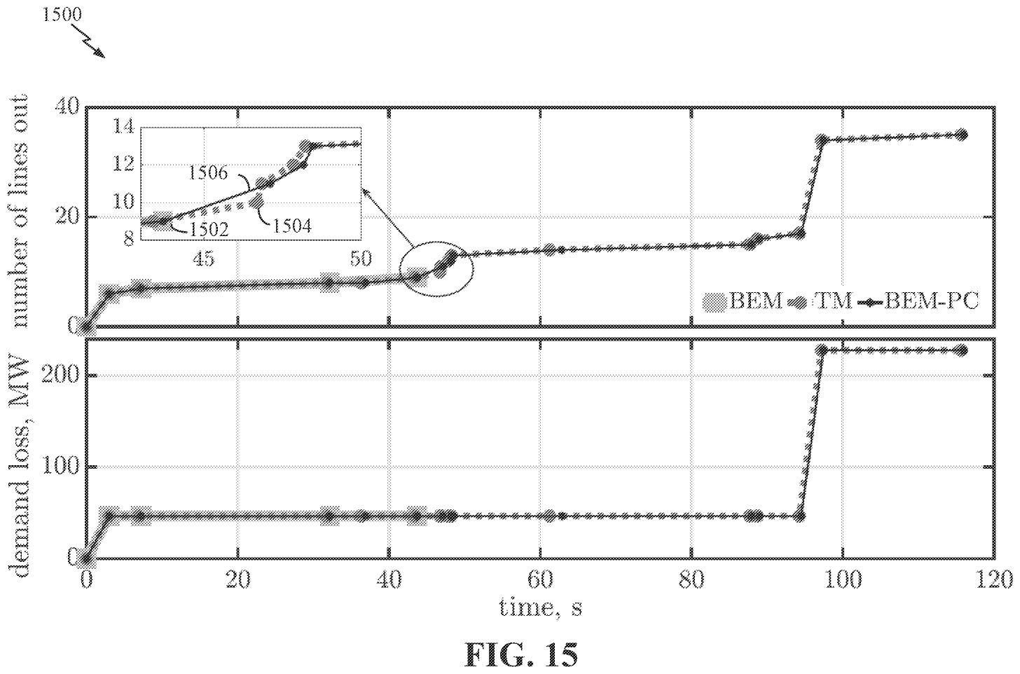

Generators G286 and G287 are selected to create the oscillatory instability in the system. FIG. 14 shows rotor speed variation in two selected machines in the system for case #2. While BEM 1406 without PC is not able to capture the oscillatory instability and diverges from the ground truth, this figure along with Tables V and VI reveal that in both cases, BEM-PC 1404 attains the identical end results of cascade as TM 1402. As an example, for case #2, BEM-PC 1404 estimates the unstable modes 0.4306+±j9.7845 and 0.4464+±j9.3910, and corresponding modeshapes in FIG. 13, which leads to tripping of G286 and G287 after a 4.5 s delay by the SPS. Finally, FIG. 15 represents branch outages and demand loss against the cascade progression time for case #2. It reveals that cascade in BEM 1502 is stopping after 4 tiers around 43 s. Although, because of very close trip delays of two overloaded lines around t=45 s, these lines are tripped together in one tier of cascade in BEM-PC 1506, and in two tiers in TM 1504, they follow identical cascade propagation paths (see, R in Table VI) and produce same results at the end-point of cascade.

TABLE V
End-of-cascade comparison: Polish System

| | | demand | lines | mach. | cascade | runtime |
|---|---|---|---|---|---|---|
| | | loss, % | out | out | time, s | ratio |
| Case | TM | 0.96362 | 34 | 4 | 90.845 | 25.74 |
| #1 | BEM-PC | 0.96362 | 34 | 4 | 90.748 | 1 |
| | BEM | 0.22591 | 9 | 1 | 11.077 | 0.15 |
| Case | TM | 0.92726 | 35 | 3 | 115.663 | 40.37 |
| #2 | BEM-PC | 0.92726 | 35 | 3 | 115.969 | 1 |
| | BEM | 0.18955 | 10 | 0 | 43.694 | 0.16 |

TABLE IV
End-of-cascade and path agreement comparison: IEEE 118- bus System

| | | error in state of | | | max error in | | | |
|---|---|---|---|---|---|---|---|---|
| | TM vs | buses | mach. | lines | \|v\|, pu | <v, deg. | f, Hz | R |
| Case | BEM-PC | 0 | 0 | 0 | 3.2 × 10⁻⁵ | 0.0012 | 7.3 × 10⁻⁵ | 1 |
| #1 | BEM | 15 | 3 | 25 | 5.7 × 10⁻² | 4.1507 | 9.7 × 10⁻⁴ | 0.9907 |
| Case | BEM-PC | 0 | 0 | 0 | 3.3 × 10⁻⁵ | 0.0012 | 7.6 × 10⁻⁵ | 1 |
| #2 | BEM | 15 | 3 | 25 | 5.7 × 10⁻² | 4.1935 | 1.1 × 10⁻³ | 0.9913 |

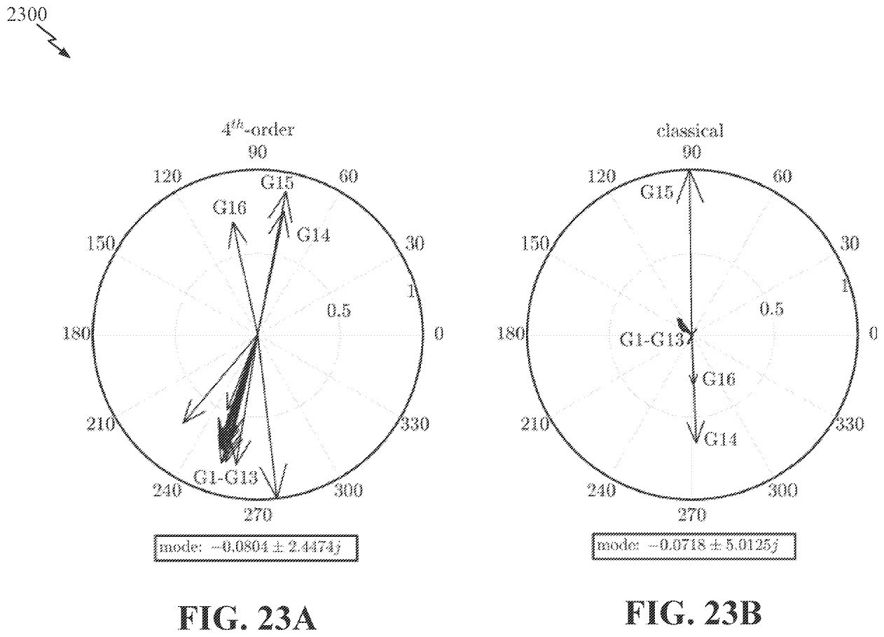

For further judging the efficacy of the disclosed BEM-PC approach in handling the hyperstability issue, it would be ideal to study a system that naturally exhibits oscillatory instability as the cascade propagates. To that end, the inventors have also considered the IEEE 68-bus New England-New York (NE-NY) benchmark test system that could be used for studying oscillatory instability problems.
3) IEEE 68-Bus NE-NY System: The system may have 5 areas, 87 lines, and 16 generators. The grid exhibits multiple oscillatory modes among which the mode with eigenvalues −0.0804±2.4474j has the least damping ratio. The modeshapes of generator speeds for this mode is shown in FIG. 23(a). The inventors run 500 Monte Carlo (MC) simulations with two random initial line outages in AMID Ryzen 7 3800X CPU with 32 GB RAM. Unlike the IEEE 118-bus and Polish systems, T_{w}^{OC}=4 s can be used, since this system exhibits low-frequency interarea modes.

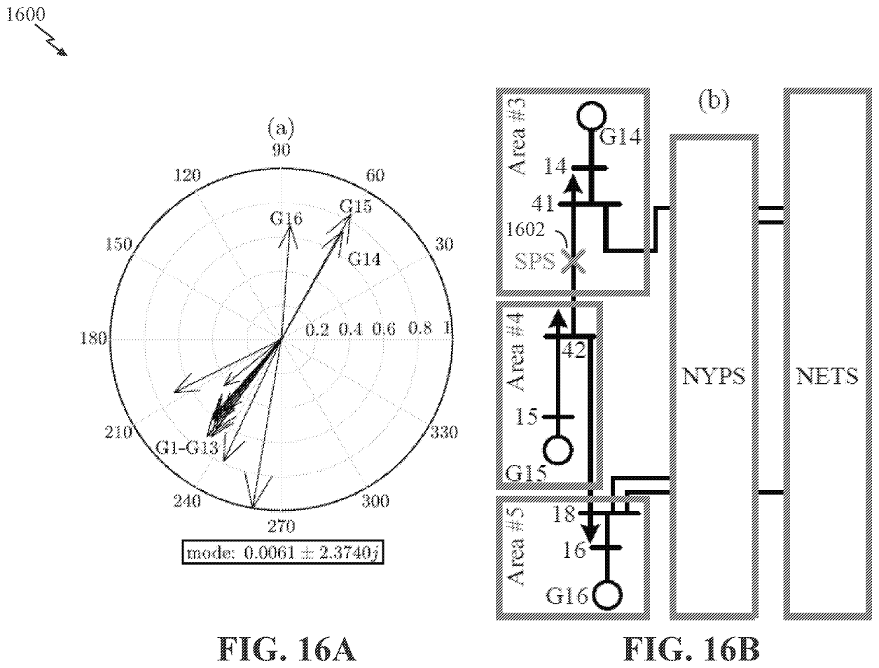

As shown in Table VII, BEM-PC encounters hyperstability issues in 16.4% of cases. The modeshapes of the generator speeds for the unstable mode with eigenvalue 0.0061±2.3740j is estimated by BEM-PC, and is shown in FIG. 16A. Clearly, the most poorly-damped mode in the predisturbance condition has become unstable during cascade propagation and generators G14-G16 oscillate against the rest of the generators in this mode. Upon prediction of hyperstability, BEM-PC performs a corrective step by tripping line 41-42 after 5 s of the latest event using the predefined SPS action 1602, see FIG. 16B.

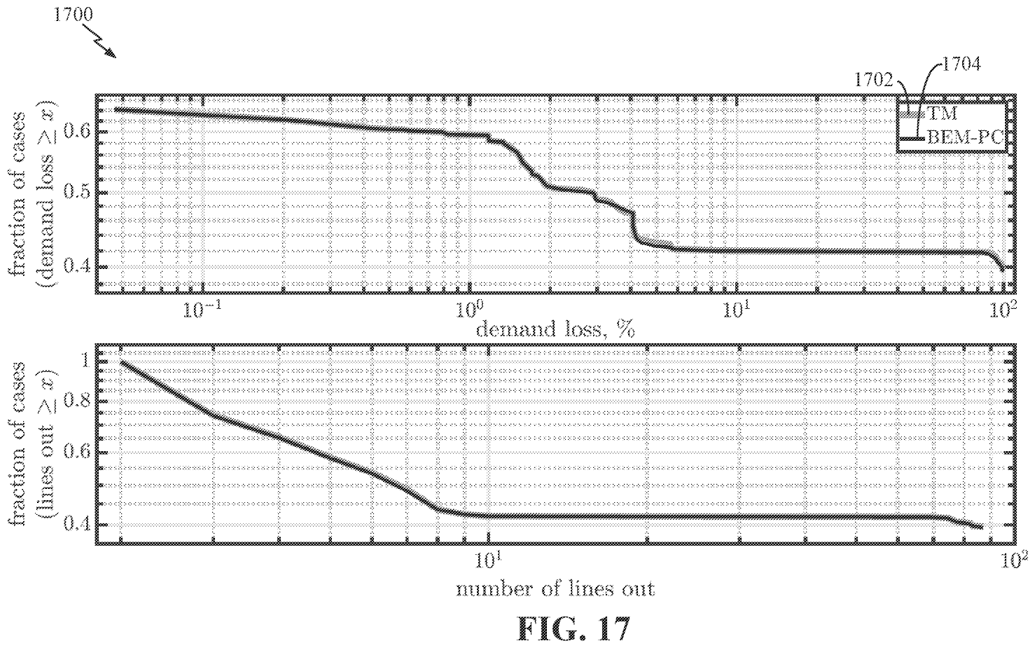

The fraction of cases where the demand loss and line outages at the end of cascade are above a threshold are compared in FIG. 17. A very close match can be seen between TM 1702 and BEM-PC 1704. Table VIII shows breakdown of errors in states of buses, machine, and lines at the end of cascade of BEM-PC 1704 along with its path agreement measure R. It can be seen that the disclosed approach is highly accurate in following the actual cascade path, while achieving ≈20× speedup on an average, in spite of naturally occurring hyperstability problem.

TABLE VII
Number of cases with/without hyperstability detection
by BEM-PC during cascade: NE-NY system

| | # of cases with | # of cases without |
|---|---|---|
| | hyperstability | hyperstability |
| Number | 82 | 418 |
| Percentage, % | 16.4 | 83.6 |

TABLE VIII
(a) End of cascade error, (b) path agreement measure,
and (c) runtime in TM w.r.t. BEM-PC: NE-NY System

| | | mean | min | max | median |
|---|---|---|---|---|---|
| Error in | Buses | 0.132 | 0 | 18 | 0 |
| state of | machines | 0.032 | 0 | 5 | 0 |
| | lines | 0.138 | 0 | 19 | 0 |

| | | | | |
|---|---|---|---|---|
| R | 0.997 | 0.428 | 1 | 1 |
| Runtime ratio | 19.687 | 0.235 | 120.737 | 15.582 |

### C. Analysis of Computational Efficiency

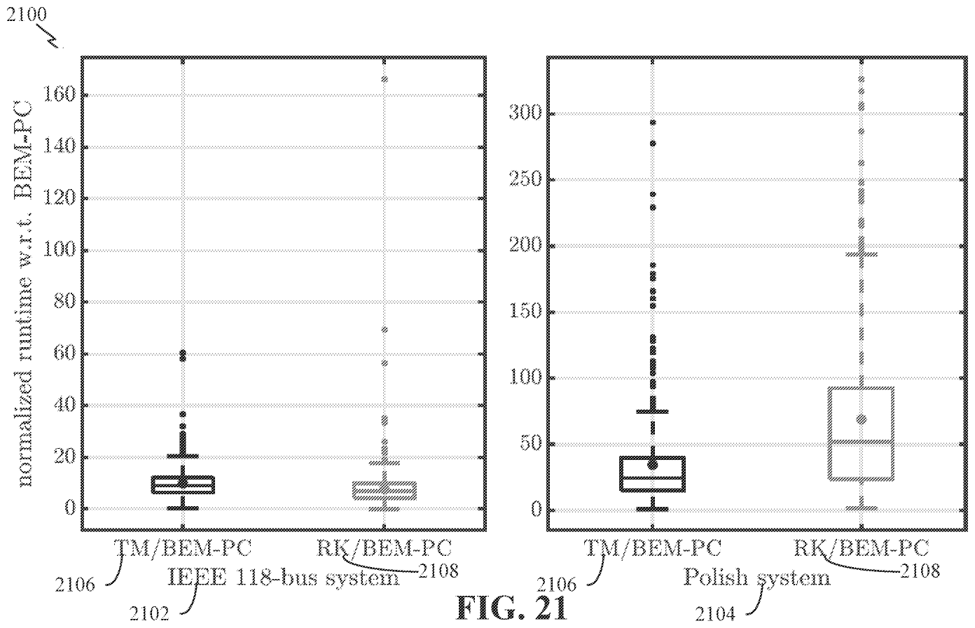

In support of the logical arguments presented in Section III-C, the analysis of computational efficiency of BEM-PC is presented based on simulation data. To that end, the inventors performed rigorous data collection relating individual subprocesses in FIG. 1. In addition to TM, performance comparison with the partitioned approach used in production-grade software is presented.
1) Performance comparison with TM: Statistical analysis of the overall CPU time comparison between BEM-PC and TM was presented using the runtime ratio in Tables I-II. The box plots of this metric are also shown in FIG. 21. Although the runtime ratio is a good measure of the overall computational efficiency of BEM-PC, it is important to understand how the individual subprocesses in FIG. 1 contribute towards that. Polish system can be chosen to demonstrate this due to the scalability challenge it poses. To this end, first two cases can be chosen.

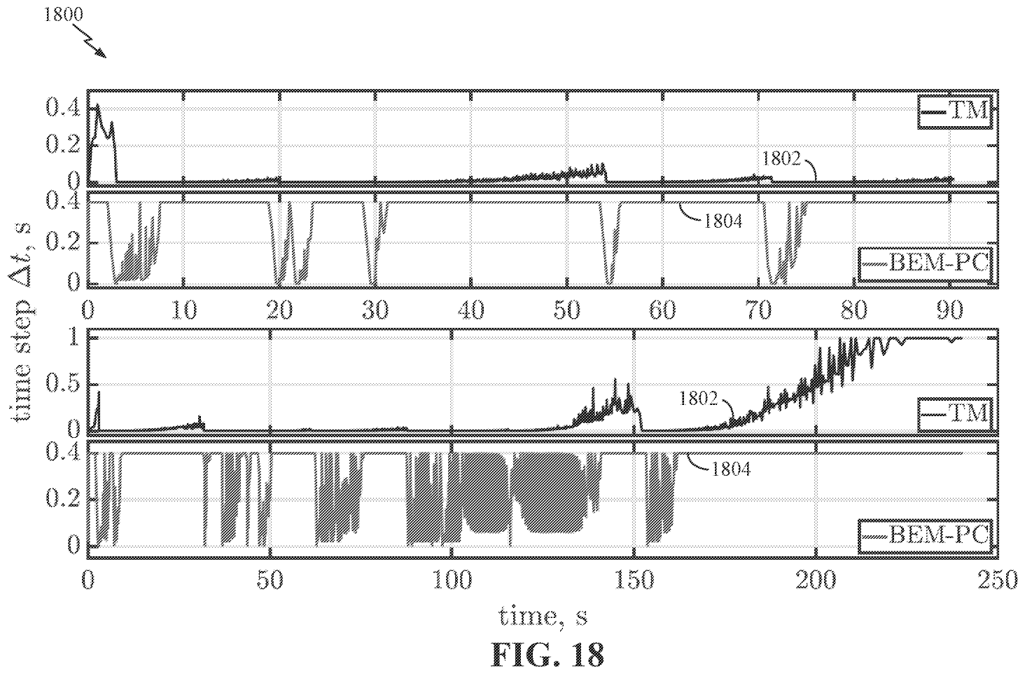

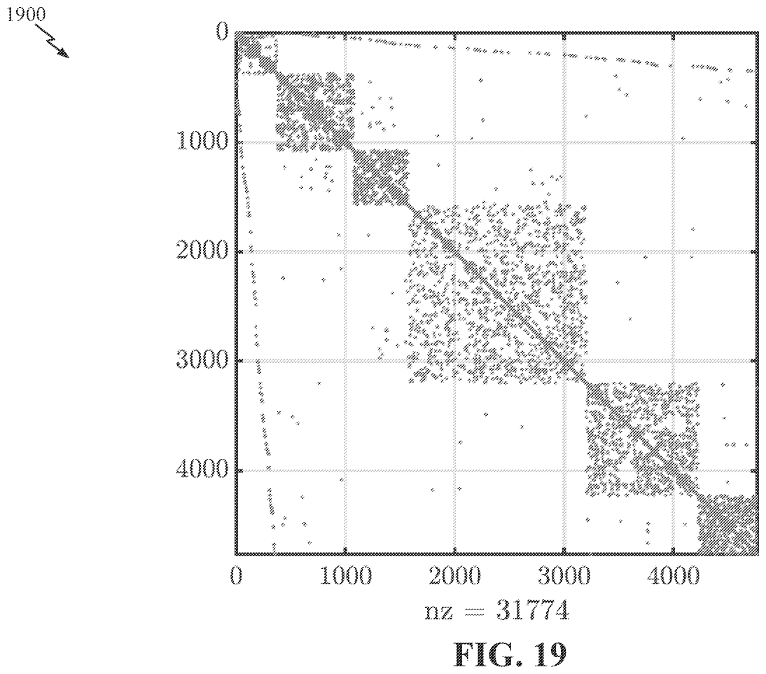

Case (I): a case without hyperstability, and Case (II): the hyperstability case #2 analyzed in the previous Section. The analysis of BEM-PC subprocesses are performed below.
1. Subprocess (a): FIG. 18 shows the adaptation of integration time step Δt in BEM-PC 1804 and TM 1802 while solving the cascading process leading to the main surviving island. It can be seen that TM 1802 demands much shorter time step whereas BEM-PC 1804 enjoys simulation with Δtₘₐₓ=0.4 s for most of the simulation period. It can be calculated from Table IX that this subprocess consumes ˜70% and ˜75% of BEM-PC's overall CPU time for Cases (I) and (II), respectively. These are however, merely ˜2% of the TM's runtime in both cases.
2. Subprocess (b): Table IX also shows a breakdown of BEM-PC's runtime within subprocess (b) in FIG. 1. As mentioned in Section III-C, this subprocess can be segmented further into (b1), (b2), and (b3). Subprocess (b1) is the most expensive among the three, and based on the runtimes shown in Table IX, it uses 23% of BEM-PC's overall CPU time for both cases. Subprocess (b2) requires inversion of the submatrix J₂₂, which is very sparse. To get an idea, FIG. 19 shows the sparsity pattern of J₂₂ in pre-disturbance condition. The dimension of the matrix is 4766×4766, and it is 99.86% sparse. It takes 2.16 s to form the corresponding largest A matrix in PSU's ROAR computers when sparse objects are used in conjunction with Matlab's most comprehensive inversion routine. The dimension of the A matrix in this case is 1964×1964, and it takes 2.5 s for its eigendemposition in subprocess (b3). Based on the results in Table IX, (b2) and (b3) consume ≈1.5-2% and ≈1.5-2.5% of total CPU time of BEM-PC, respectively. Note that the subprocess (c) is lookup table-based and consumes negligible CPU time.

TABLE IX
Runtime in seconds of different sub-processes in BEM-PC shown
in FIG. 3. Case (I): generic case without hyperstability,
and Case (II): with hyperstability in Polish system

| | BEM-PC | | | | | | | | | |
|---|---|---|---|---|---|---|---|---|---|---|
| | round 1 | | | | round 2 | | | | | TM |
| Case | a | b1 | b2 | b3 | a | b1 | b2 | b3 | Total | Total |
| I | 829.3 | 276.5 | 25.2 | 28.5 | 0 | 0 | 0 | 0 | 1159.5 | 37615.2 |
| II | 440.2 | 103.9 | 8.1 | 8.3 | 1608.0 | 528.2 | 32.2 | 33.2 | 2762.1 | 111521.0 |

a: subprocess (a)
b1: equilibrium calculation in subprocess (b)
b2: A matrix calculation attained from (14) in subprocess (b)
b3: eigen decomposition in subprocess (b), see FIG. 3

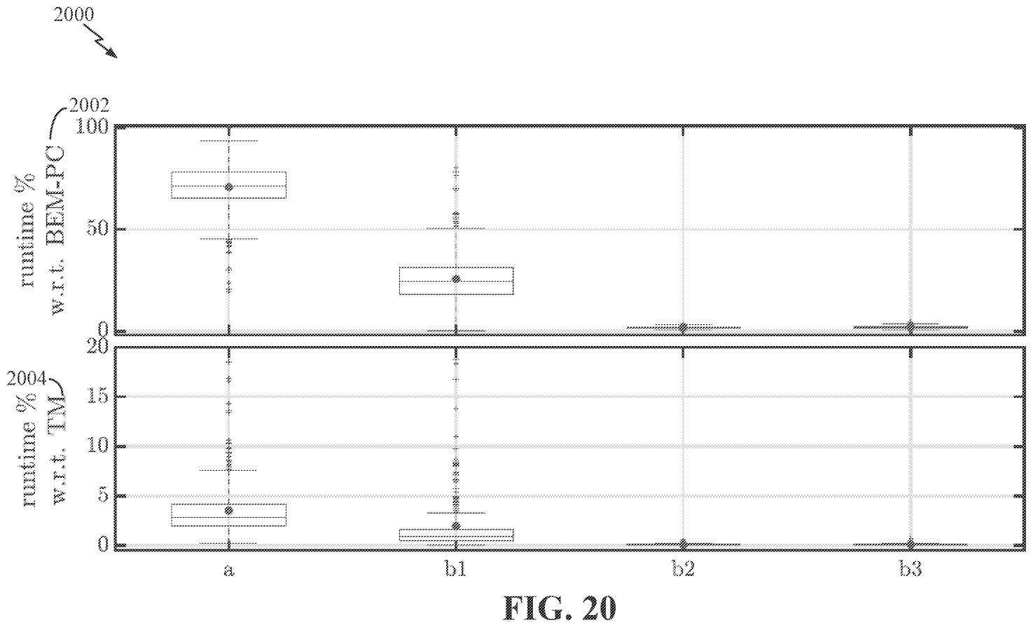

After an in-depth analysis of two specific cases, statistical analysis is performed to assess the computational burden of the subprocesses in 500 cases of Polish system. FIG. 20 shows the boxplots of these runtimes expressed as percentages of total runtimes of BEM-PC 2002 and TM 2004. Boxplots of runtimes of different subprocesses of BEM-PC 2002 as in FIG. 1 during 500 MC runs of Polish system. a: subprocess (a). b1: equilibrium calculation in subprocess (b). b2: A matrix calculation from Equation (14) in subprocess (b), and b3: eigendecomposition of A matrix in subprocess (b). Runtimes are expressed as a % of total runtimes of BEM-PC 2002 and TM 2004. The mean and median figures are specified in Table X. The following conclusions can be drawn from these data—
1) Subprocess (a) consumes the most significant computational burden followed by (b1). In comparison, both calculation of A matrix and its eigendecomposition requires negligible CPU time.
2) Aided by the stiff-decay property, both of subprocesses and (b1) run significantly faster than TM due to their ability to use larger integration step length Δt.

TABLE X
Mean and median values of runtimes of different subprocesses
of BEM-PC in FIG. 3 as a % of total runtime of BEM-PC
and TM in 500 MC runs for Polish system

BEM subprocess

| | | a | b1 | b2 | b3 |
|---|---|---|---|---|---|
| mean | BEM-PC | 70.69 | 25.62 | 1.71 | 1.98 |
| | TM | 3.51 | 1.98 | 0.08 | 0.09 |
| median | BEM-PC | 71.42 | 24.41 | 1.7 | 1.94 |
| | TM | 2.82 | 0.87 | 0.06 | 0.07 |

2) Performance comparison with partitioned approach: As described in the Introduction section, production grade stability programs use the partitioned approach for dynamic simulation. For a fair comparison, cascading failure simulations can be performed using the partitioned approach with 4th-order Runge-Kutta (R-K) method, which is an explicit numerical integration technique. The simulations were run at a fixed time-step of 0.002 s. Both R-K and TM produces near-identical simulation results. Boxplots of normalized runtime of R-K w.r.t. BEM-PC are shown in FIG. 21. The following are the key observations:
1) For the relatively smaller IEEE 118-bus system 2102, R-K 2108 is slightly faster than the TM 2106. However, the mean and median ratios of runtime between R-K and BEM-PC from 500 MC runs are 7.72 and 6.91, respectively. For TM these numbers are 9.96 and 9.05, respectively.
2) For the Polish system 2104, R-K is slower than TM. The mean and median ratios of runtime between R-K and BEM-PC from 393 MC runs are 68.82 and 51.84, respectively. For TM, these numbers corresponding to the same MC runs are 34.54 and 24.44, respectively. Note that the remaining 107 cases of the 500 MC runs could not be simulated using R-K method as those are running beyond 60 hours.

Clearly, BEM-PC retains its advantage over traditional partitioned approach. This is in line with description above.

D. Comparison with AC-QSS and Classical Models

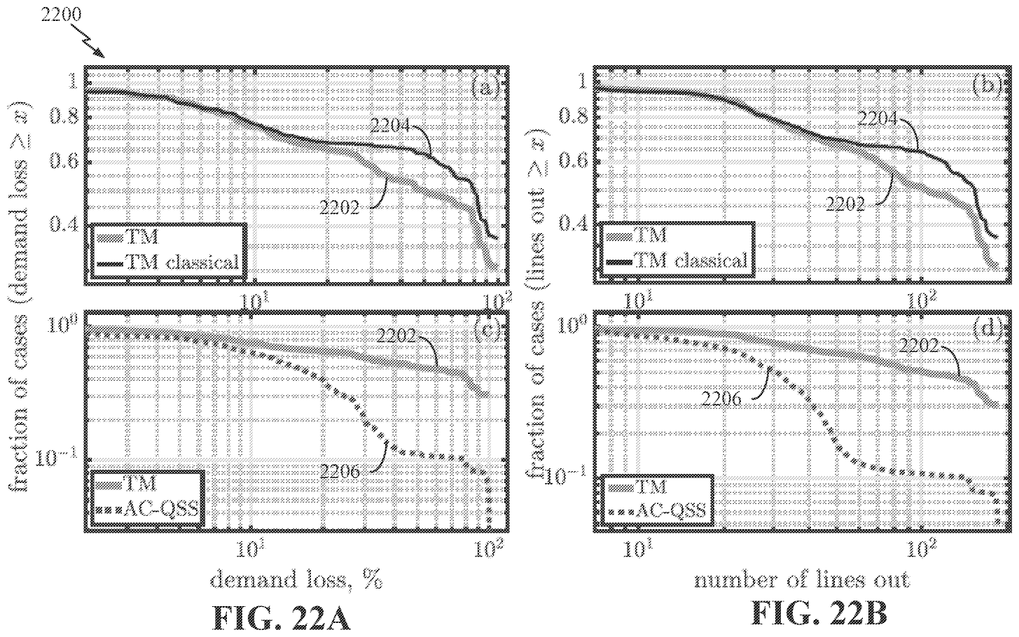

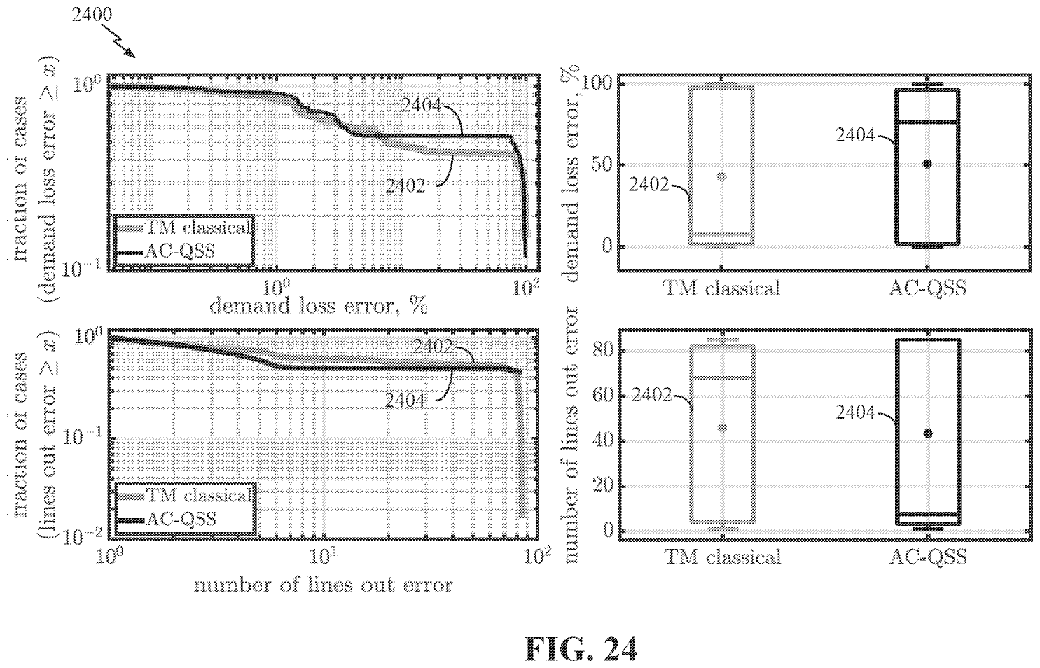

In this section, the inventors contrast the cascading failure simulation results in the ground truth (that uses a 4th-order generator model solved using TM) with the AC-QSS model and dynamic model with classical generator representation. Going forward, ‘error’ will imply difference w.r.t. ground truth denoted as ‘TM.’
1) IEEE 118-Bus System: FIG. 22 shows that both models demonstrate similarity with the 4th-order model, when cascading failure is less severe. However, as the cascade leads to further line outages and load tripping, the AC-QSS 2206 and the classical model 2204 start departing from the ground truth. For this system, the AC-QSS 2206 model shows an optimistic result, while the classical model 2204 presents a pessimistic result, when compared with the ground truth 2202.
2) IEEE 68-Bus NE-NY System: The inventors first look into the modal characteristics of the system before initial outages. The modeshapes of generator speeds corresponding to the most poorly-damped modes are shown in FIG. 23A for 4^{th}-order synchronous generator representation vs classical model representation shown in FIG. 23B. Next, Table XI shows the number of cases with nonzero error with respect to ground truth in line outage and demand served at the end of cascade when classical generator-based model and AC-QSS model are used in NE-NY system. Finally, FIG. 24 quantifies the error in such cases. The following are the key observations from FIGS. 23, 24, and Table XI.

The modal characteristics of the 4th-order and classical model-based systems are quite different. For the former, the most poorly-damped mode is −0.0804±2.4474j, whereas for the latter, it is −0.0718±5.0125j. In 4th-order model, generators G14-16 oscillate against those in NETS and NYPS for this mode, whereas for the classical model, G15 oscillates against G14 and G16 for the corresponding mode.

FIG. 24 reveals that in the classical model 2402 among the cases in Table XI the mean demand loss error is higher than 40% and the mean line outage error is more than 40. These errors are similar for the AC-QSS model 2404, but for a much larger number of cases, as shown in Table XI.

TABLE XI
Number of cases with nonzero errors in demand loss and line
outage at the end of cascade comparing ground truth (TM) against
classical and AC-QSS models: NE-NY and Polish systems

| # of cases with error in | |
|---|---|
| Demand loss | Lines out |

| TM vs | NE-NY | Polish | NE-NY | Polish |
|---|---|---|---|---|
| TM classical | 79 | 76 | 62 | 113 |
| AC-QSS | 297 | 296 | 322 | 342 |

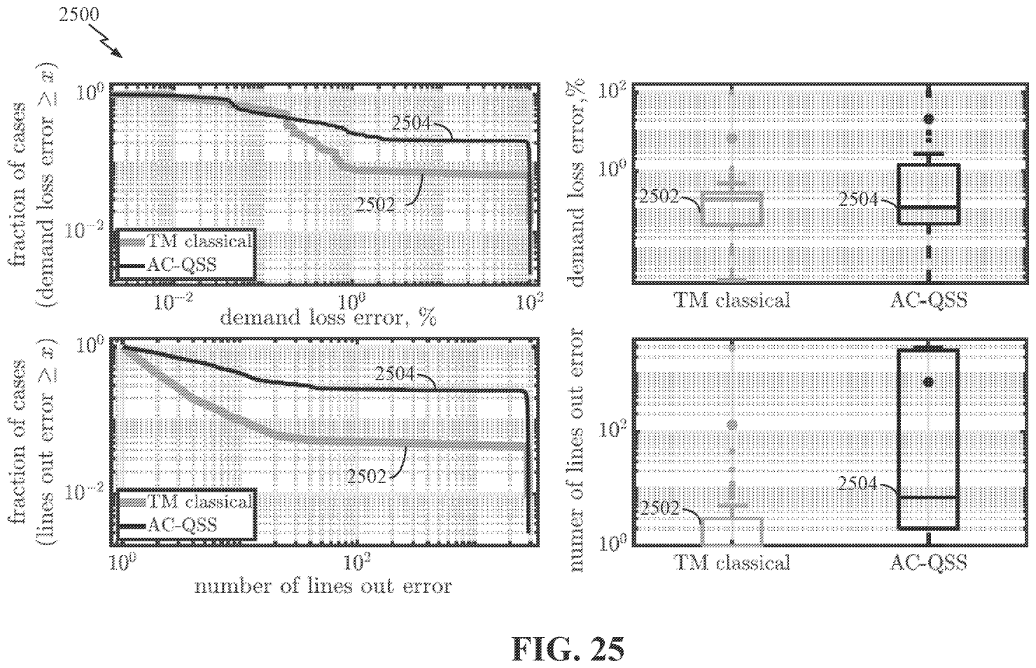

3) Polish System: Table XI shows the number of cases with nonzero error with respect to ground truth in line outage and demand served at the end of cascade when classical generator-based model and AC-QSS model are used in Polish system. FIG. 25 quantifies the error in such cases. In line with the expectations, the AC-QSS model 2504 shows higher error than the classical model 2502.

### VI. EXAMPLE PROCESSES

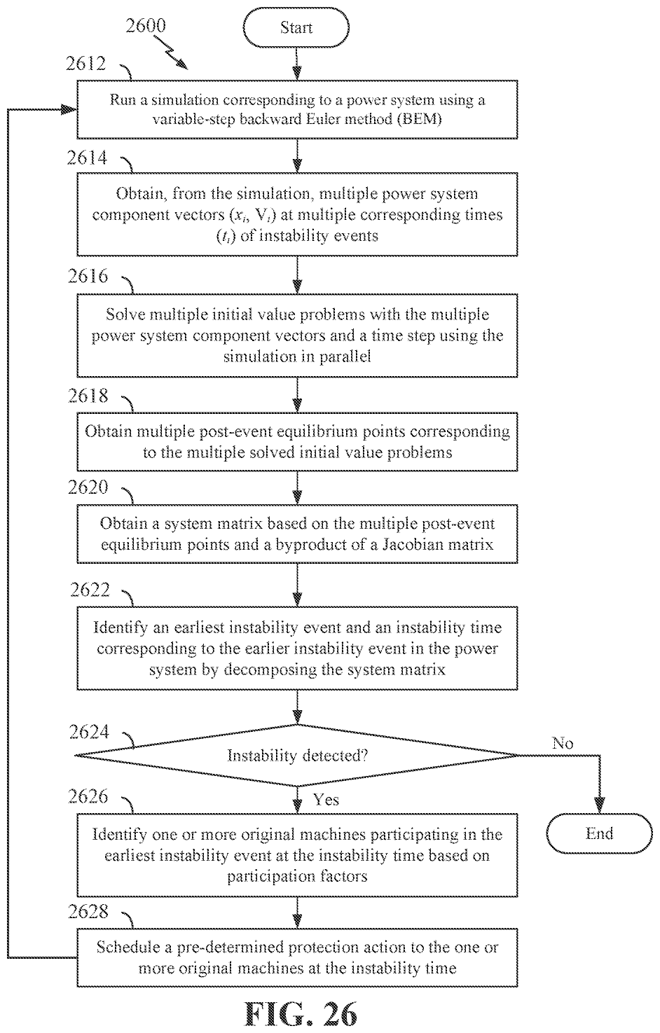

FIG. 26 is a flow chart illustrating an exemplary process 2600 for cascading failure and prevention in a power system in accordance with some aspects of the present disclosure. As described below, a particular implementation may omit some or all illustrated features and may not require some illustrated features to implement all embodiments. In some examples, any suitable apparatus or means for carrying out the functions or algorithm described below may carry out the process 2600.

In block 2612, the apparatus may run a simulation corresponding to the power system. For example, the apparatus may use a computer program stored in a memory to model the time-varying behavior of the power system. In some examples, the simulation may be represented by a set of nonlinear differential algebraic equations (DAEs). For example, a DAE can be expressed by \dot{x}=ƒ(x,V), where x∈ [symbol] ⁿ is the state vector consisting of individual device state, and V∈ [symbol] ^{m} indicates the vector of real and imaginary components of bus voltages. The power system may include multiple devices (e.g., power stations) and buses to deliver power. In some examples, the power system may be an electric power grid. However, it should be appreciated that the simulation is not limited to the power system. The simulation may be used for any dynamical system. The simulation may use a variable-step backward Euler method (BEM). In some examples, the simulation can be obtained by discretizing the DAE (\dot{x}=ƒ(x,V)) using BEM. The simulation can be expressed by F (xₙ₊₁, Vₙ₊₁)=xₙ₊₁−xₙ−Δt ƒ(xₙ₊₁, Vₙ₊₁). In some instances, the variable-step BEM determines the time step (Δt) based on a hyperparameter to be tuned and a first mismatch vector. The time step or step size can be expressed by:

$$Δ {t}_{n + 1} = {Δt}_{n} \frac{τ}{{‖ {F}_{x}^{0} ‖}_{∞}} ;$$

Δtₖ∈[Δtₘᵢₙ, Δtₘₐₓ], where ∥Fₓ⁰∥_{∞} shows the largest component of the first mismatch vector and τ is a hyperparameter to be tuned. In a non-limiting example, the apparatus may run the simulation with Δt=0.002 s for a predetermined k steps. Here, the hyperparameter (τ) can be a user-defined constant value equal to 1e-3 (1×10⁻³). At the solution point, all elements of mismatch vector for differential equations F(xₙ,Vₙ) are going to be 0. However, a set of differential and algebraic equations can be solved simultaneously, and Newton's method can be used iteratively. Fₓ⁰ can show the mismatch vector in the first iteration of Newton's method and ∥Fₓ⁰∥_{∞} can show the largest absolute value of this vector. So, if the steady state of the system is approached, value of ∥Fₓ⁰∥_{∞} will decrease (small mismatch) and consequently the time step of BEM method will increase.

In block 2614, the apparatus may obtain, from the simulation, multiple power system component vectors (xᵢ, Vᵢ) at multiple corresponding times (tᵢ) of instability events. Here, the times (tᵢ) are times of events, such as line outages and machine outages in the system. In some examples, all of events/outages can lead to instability in the system. In other examples, a part of all events/outages can lead to instability in the system. In further examples, the value of ‘tᵢ’ corresponding to an instability event can be shown by ‘t_{f}’ in FIG. 1. In some examples, the apparatus may obtain the multiple power system component vectors in series at multiple corresponding times. In some examples, each of the plurality of system component vectors may include a device state vector (xᵢ) for a plurality of devices in the power system and a bus voltage vector (Vᵢ) for a plurality of bus voltages in the power system. A topology of the power system may be altered at each of the plurality of times. In some examples, the topology of the power system may be altered due to unstable scenarios. The unstable scenario may include an unstable local voltage, unstable frequency, an unstable non-oscillatory angle, and/or an unstable local oscillatory angle. In some examples, an unstable scenario is the one that, if left unattended, will lead to local or system-wide blackout. Such an instability may be initiated by faults followed by tripping of different components. This results in the unstable local voltage, frequency, non-oscillatory angle, and/or local oscillatory angle. What is common in typical signatures of unstable variables (e.g., voltage, frequency, and angle) is monotonicity—monotonicity in the growth of oscillation amplitude, monotonicity in the trend of non-oscillatory behavior in the form of increasing or decreasing values over time. There are no range of values to determine this, but the preventive actions may rely upon certain thresholds in such variables.

In block 2616, the apparatus may solve multiple initial value problems (IVPs) with the multiple power system component vectors and a time step using the simulation in parallel. Equations (1)-(3) are nonlinear in variables x and V, and therefore does not have analytical solution. So, they are solved numerically. The numerical integration methods used in this process require discretization of the continuous functions involved in this equation. The discretization time-step is Δt. The time-step length determines how frequently the variables x and V are updated. In some examples, Newton's method can be used to solve a linearized set of differential and algebraic equations simultaneously. Differential functions can be functions of time like p=ƒ(t). Linearization of these continuous functions of times is happening through discretization of continuous functions which introduces “time step.” Thus, the time values are normally very small values. In a non-limiting example for BEM, the minimum and maximum values can be defined equal to 0.02 s and 0.4 s.

In some examples, a part of the disclosed approach can predict possible oscillatory instabilities in the system. Thus, each one of post-event situations in the power network can be considered as a separate problem with corresponding post-event initial condition. It defines solving IVPs (Initial Value Problems). In further examples, solving IVP is solving set of differential algebraic equations that it is happening through Newton method that is solving linearized differential and algebraic equations (e.g., Equations 1-3). As Equations 1-3 are complicated, the linearized form of them can be solved through Equations 5-10. F is a mismatch function defined to linearize differential equation \dot{x}=ƒ. In some aspects of the disclosure, solving the IVPs (post-event unstable equilibrium point(s)) means that the values of x and V need to be found as time t increases—given that the initial values (xᵢ, Vᵢ) are known at t=0. The function ƒ(⋅) can be a nonlinear function including the power system's dynamic model including those of synchronous generators and other dynamical elements that may be present. The function F (⋅) is defined in Equation (4) above. For example, the apparatus may solve IVPs with initial values (xᵢ, Vᵢ) that can be run in the ith parallel processor using the variable-step BEM for the time step (Δt) when BEM's stopping criterion is met. The simulation for the i^{th} independent IVP is stopped if the speed variation of machines in a predetermined window length is below a certain threshold. As shown in FIG. 1, t_{d,i} is the time elapsed since the beginning of such a simulation when this stopping criterion is met.

In block 2618, the apparatus may obtain multiple post-event equilibrium points corresponding to the multiple solved IVPs. For example, solving multiple IVPs in parallel may allow the apparatus to obtain multiple corresponding post-event unstable equilibrium points. Although the apparatus may ignore fast oscillations and obtain a coarse picture of the trajectories of the power system thought the BEM, the BEM is not able to detect oscillatory instability because the BEM converges to the unstable equilibrium point. Thus, the apparatus addresses this hyperstability issue of the BEM in blocks 2620-2622.

In block 2620, the apparatus may obtain a system matrix (A matrix) based on the multiple post-event equilibrium points and a byproduct of a Jacobian matrix. For example, the system matrix (A matrix) can be calculated by: A=P₁₁+P₁₂P₂₂⁻¹P₂₁. Here,

$${P}_{11} = \frac{1}{Δ t} ( I - {J}_{11} ) ; {P}_{12} = - \frac{1}{Δ t} ( {J}_{12} ) ; {P}_{21} = - {J}_{21} ; and {P}_{22} = {J}_{22} .$$

Here, I denotes the identity matrix, where The identity matrix of size n is the n×n square matrix with ones on the main diagonal and zeros elsewhere. J₁₁, J₁₂, J₂₁, and J₂₂ are elements of the Jacobian matrix (J). The Jacobian matrix (J) can be expressed as:

$$[ J ] = {[ \begin{matrix}\frac{\partial F}{\partial {x}_{n + 1}} & \frac{\partial F}{\partial {V}_{n + 1}} \\ \frac{\partial G}{\partial {x}_{n + 1}} & \frac{\partial G}{\partial {V}_{n + 1}}\end{matrix} ]}_{n + 1}^{k} = [ \begin{matrix}{J}_{11} & {J}_{12} \\ {J}_{21} & {J}_{22}\end{matrix} ] ,$$

where F (xₙ₊₁, Vₙ₊₁)=0 and G (xₙ₊₁, Vₙ₊₁)=YₙVₙ₊₁−I (xₙ₊₁, Vₙ₊₁)=0. Here, F and G functions in the Jacobian matrix can be mismatch functions that are used in the linearization of non-linear differential and algebraic equations, respectively as shown in Equations 4, 5, and 10 above.

In block 2622, the apparatus may identify an earliest instability event and an instability time corresponding to the earlier instability event in the power system by decomposing the system matrix (A matrix). Here, the instability event can be represented by t_{f} as shown FIG. 1. Not necessarily all of events are unstable events. In some examples, the apparatus may decompose the system matrix (A matrix) into an eigen vector and an eigenvalue. In addition, the apparatus may use selective unstable eigenvalue and corresponding right eigenvector calculation using the S-method. In some examples, some modes (eigenvalue pairs) may create oscillatory instability in the system. So, complex conjugate eigenvalues E=a +jb and E=a−jb can be found. The complex conjugate eigenvalues may satisfy: 1) a >0 (this introduces unstable behavior to the mode), and 2) b is a non-zero value (this introduces oscillatory behavior to the mode). Thus, the apparatus may identify the earliest instability event and corresponding time instant (t_{f}) in which the stability occurs.

In block 2624, the apparatus may detect instability in the power system. When there is no instability in the power system, the apparatus may end the exemplary process 2600. When the apparatus identifies an instability in the power system, the apparatus may proceed with block 2626.

In block 2626, the apparatus may identify one or more original machines participating in the earliest instability event at the instability time based on participation factors. In some examples, the one or more original machines are identified further based on a modeshape. Here, the right eigenvector of a square matrix corresponding to an eigenvalue is called the modeshape of the eigenvalue. In some examples, participation factor of a state in a mode (eigenvalue pair) may be the product of the corresponding elements of the left and the right eigenvectors.

In block 2628, the apparatus may schedule a predetermined protection action to the one or more original machines at the instability time. For example, the apparatus may schedule functional implementation of the predetermined protective action that will take place following the time t=t_{f} (the time of the earliest instability event) in the ground truth after a designed delay. Then, the apparatus may reinitiate the simulation in block 2612 with the predetermined protection action to the one or more original machines at the instability time. Thus, after scheduling the predetermined protection action, the apparatus can reinitiate the solution of IVPs at t=t_{f} with initial states x_{f}, V_{f} and perform protection actions after a pre-defined delay and continue solving the subsequent IVPs. The above steps can be repeated until no instability is detected in block 2624.

### VII. HARDWARE CONFIGURATION EXAMPLE

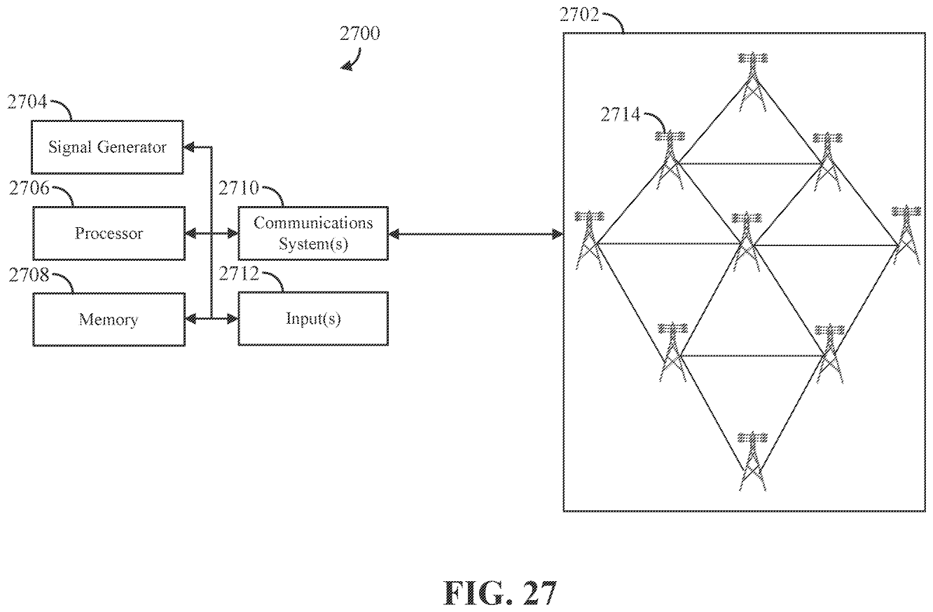

FIG. 27 is a block diagram conceptually illustrating an example of a system for cascading failure detection and prevention in a power system in accordance with some embodiments of the disclosed subject matter. As shown in FIG. 27, the system 2700 may include a processor 2706, a signal generator 2704, a memory 2708, a communication system(s) 2710, and/or an input(s) 2712. The system 2700 may communicate with a power system 2702 using a communication system(s) 2710.

For example, the power system 2702 may include multiple nodes interconnected to each other. An outage of a node may cause the failure of other nodes in the power system 2702. In some examples, the system 2700 may receives instability events of one or more nodes 2714 and the status of the nodes 2714 and generate a simulation corresponding to power system 2702. Based on a result of the simulation in the system 2700, the system 2700 may schedule a pre-determined protection action to one or more nodes or machines at the instability time in a power system 2702.

The system 2700 may also include the processor 2706 for controlling operations of the system 2700. The processor may include any suitable hardware processor (e.g., a microprocessor, digital signal processor, a microcontroller, an image processor, a GPU, etc., one or more of which can be implemented using a field programmable gate array (FPGA) or an application specific integrated circuit (ASIC)) or combination of hardware processors.

In some embodiments, memory 2708 can include a storage device (e.g., a hard disk, a solid state drive, a Blu-ray disc, a Digital Video Disk (DVD), RAM, ROM, EEPROM, etc.) for storing a computer program for controlling processor 2706. In some embodiments, memory 2708 can include instructions for causing processor 2706 to execute processes associated with the mechanisms described herein, such as processes described below in connection with FIG. 26.

In some embodiments, the signal generator 2704 can be one or more signal generators that can generate signals to the power system 2702 using a signal. In some examples, the signal may include a pre-determined protection action to one or more nodes or machines at the instability time in the power system 2702.

In some embodiments, the system 2700 can communicate with the power system 2702 over a network using the communication system(s) 2710 and a communication link. Communications by the communication system 2710 via a communication link can be carried out using any suitable computer network, or any suitable combination of networks, including the Internet, an intranet, a wide-area network (WAN), a local-area network (LAN), a wireless network, a digital subscriber line (DSL) network, a frame relay network, an asynchronous transfer mode (ATM) network, a virtual private network (VPN). The communications link can include any communication links suitable for communicating data between the system 2700 and the power system 2702, such as a network link, a dial-up link, a wireless link, a hard-wired link, any other suitable communication link, or any suitable combination of such links.

In some embodiments, the system 2700 may further include an input device 2712 for accepting input from a user and/or from any other device or system.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

Accordingly, various systems and methods are disclosed herein that can implement a number of fast time-domain cascading failure simulation approaches, which may be based on implicit Backward Euler method (BEM) with stiff decay property. To solve the hyperstability problem of BEM, some embodiments may provide for a parallelizable predictor-corrector (BEM-PC) approach requiring eigendecomposition of the system matrix corresponding to the linear model obtained around the post-event unstable equilibrium, which BEM converges to. The system matrix is obtained as a by-product of BEM. Various configurations and implementations of the disclosed BEM-PC approach were benchmarked in a serial implementation against the traditional Trapezoidal method (TM)-based approach. The disclosed configurations and implementations showed on an average ≈10× speedup in IEEE 118-bus system, ≈35× speedup in IEEE 68-bus system, and ˜35× speedup in the Polish system based on 500 simulations in each system with random node outages while following exact cascade paths and end results as in TM in most of the cases. It was also shown that BEM-PC retains its computational advantage with respect to partitioned approach using Runge-Kutta-based numerical integration method. Finally, it was shown that AC-Quasi-Steady-State and classical generator model-based representations can lead to different results when compared with a detailed model with 4th-order generator and exciter dynamics.

### Further Examples Having a Variety of Features

Example 1: A method, apparatus, and non-transitory computer-readable medium for contingency analysis for offline planning and online operations, including: running a simulation corresponding to a power system; obtaining, from the simulation, a plurality of power system component vectors corresponding to a plurality of times, a topology of the power system being altered at each of the plurality of times; solving a plurality of initial value problems with the plurality of power system component vectors for a time step using the simulation in parallel; obtaining a plurality of post-event equilibrium points corresponding to the plurality of solved initial value problems; obtaining a system matrix based on the plurality of post-event equilibrium points; identifying an earliest instability event and an instability time corresponding to the earliest instability event in the power system by decomposing the system matrix; identifying one or more original machines participating in the earliest instability event at the instability time based on participation factors; and scheduling a pre-determined protection action to the one or more original machines in the power system at the instability time.

Example 2: The method, apparatus, and non-transitory computer-readable medium of Example 1, wherein the simulation uses a variable-step backward Euler method.

Example 3: The method, apparatus, and non-transitory computer-readable medium of any of Examples 1 to 2, wherein the variable-step backward Euler method determines the time step based on a hyperparameter to be tuned and a first mismatch vector.

Example 4: The method, apparatus, and non-transitory computer-readable medium of any of Examples 1 to 3, wherein each of the plurality of power system component vectors comprises a device state vector for a plurality of devices in the power system and a bus voltage vector for a plurality of bus voltages in the power system.

Example 5: The method, apparatus, and non-transitory computer-readable medium of any of Examples 1 to 4, wherein the topology of the power system is altered in at least one of: an unstable local voltage, an unstable frequency, an unstable non-oscillatory angle, or an unstable local oscillatory angle.

Example 6: The method, apparatus, and non-transitory computer-readable medium of any of Examples 1 to 5, wherein the plurality of power system component vectors are obtained in series.

Example 7: The method, apparatus, and non-transitory computer-readable medium of any of Examples 1 to 6, wherein the system matrix is calculated further based on a byproduct of a Jacobian matrix.

Example 8: The method, apparatus, and non-transitory computer-readable medium of any of Examples 1 to 7, wherein the system matrix is calculated by: A=P₁₁+P₁₂P₂₂⁻¹P₂₁, where A is the system matrix,

$${P}_{11} = \frac{1}{Δ t} ( I - {J}_{11} ) , {P}_{12} = - \frac{1}{Δ t} ( {J}_{12} ) , {P}_{12} = - \frac{1}{Δ t} ( {J}_{12} ) , {P}_{21} = - {J}_{21} ,$$

$${P}_{22} = {J}_{22} , where {J}_{11} = \frac{\partial F}{\partial {x}_{n + 1}} , {J}_{12} = \frac{\partial F}{\partial {V}_{n + 1}} , {J}_{21} = \frac{\partial G}{\partial {x}_{n + 1}} , {J}_{22} = \frac{\partial G}{\partial {V}_{n + 1}} ,$$

$$F ( {x}_{n} + 1 , {V}_{n + 1} ) = 0 , G ( {x}_{n + 1} , {V}_{n + 1} ) = 0 ,$$

I is an identity matrix, and Δt is the time step.

Example 9: The method, apparatus, and non-transitory computer-readable medium of any of Examples 1 to 8, wherein the decomposing the system matrix comprises decomposing the system matrix into an eigen vector and an eigenvalue.

Example 10: The method, apparatus, and non-transitory computer-readable medium of any of Examples 1 to 9, wherein the one or more original machines are identified further based on a modeshape.

Example 11: The method, apparatus, and non-transitory computer-readable medium of any of Examples 1 to 10, further comprising: rerunning the simulation with a reinitiated power system component vector at the instability time and the pre-determined protection action.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for contingency analysis for offline planning and online operations comprising:
running a simulation corresponding to a power system;
obtaining, from the simulation, a plurality of power system component vectors corresponding to a plurality of times, a topology of the power system being altered at each of the plurality of times;
solving a plurality of initial value problems with the plurality of power system component vectors for a time step using the simulation in parallel;
obtaining a plurality of post-event equilibrium points corresponding to the plurality of solved initial value problems;
obtaining a system matrix based on the plurality of post-event equilibrium points;
identifying an earliest instability event and an instability time corresponding to the earliest instability event in the power system by decomposing the system matrix;
identifying one or more original machines participating in the earliest instability event at the instability time based on participation factors; and
scheduling a pre-determined protection action to the one or more original machines in the power system at the instability time.

2. The method of claim 1, wherein the simulation uses a variable-step backward Euler method.

3. The method of claim 2, wherein the variable-step backward Euler method determines the time step based on a hyperparameter to be tuned and a first mismatch vector.

4. The method of claim 1, wherein each of the plurality of power system component vectors comprises a device state vector for a plurality of devices in the power system and a bus voltage vector for a plurality of bus voltages in the power system.

5. The method of claim 1, wherein the topology of the power system is altered in at least one of: an unstable local voltage, an unstable frequency, an unstable non-oscillatory angle, or an unstable local oscillatory angle.

6. The method of claim 1, wherein the plurality of power system component vectors are obtained in series.

7. The method of claim 1, wherein the system matrix is calculated further based on a byproduct of a Jacobian matrix.

8. The method of claim 1, wherein the system matrix is calculated by:
$$A = {P}_{11} + {P}_{12} {P}_{22}^{- 1} {P}_{21} ,$$
where A is the system matrix,
$${P}_{11} = \frac{1}{Δ t} ( I - {J}_{11} ) , {P}_{12} = - \frac{1}{Δ t} ( {J}_{12} ) , {P}_{12} = - \frac{1}{Δ t} ( {J}_{12} ) , {P}_{21} = - {J}_{21} ,$$
$${P}_{22} = {J}_{22} , where {J}_{11} = \frac{\partial F}{\partial {x}_{n + 1}} , {J}_{12} = \frac{\partial F}{\partial {V}_{n + 1}} , {J}_{21} = \frac{\partial G}{\partial {x}_{n + 1}} , {J}_{22} = \frac{\partial G}{\partial {V}_{n + 1}} ,$$
$$F ( {x}_{n} + 1 , {V}_{n + 1} ) = 0 , G ( {x}_{n + 1} , {V}_{n + 1} ) = 0 ,$$
I is an identity matrix, and Δt is the time step.

9. The method of claim 1, wherein the decomposing the system matrix comprises decomposing the system matrix into an eigen vector and an eigenvalue.

10. The method of claim 1, wherein the one or more original machines are identified further based on a modeshape.

11. The method of claim 1, further comprising:
rerunning the simulation with a reinitiated power system component vector at the instability time and the pre-determined protection action.

12. A system for contingency analysis for offline planning and online operations comprising:
a power system;
a simulation system comprising:
a memory;
a processor coupled to the memory and configured to:
receive configurations of the power system from the power system;
configure a simulation to correspond to the power system based on the configurations of the power system;
run the simulation corresponding to a power system;
obtain, from the simulation, a plurality of power system component vectors corresponding to a plurality of times, and a topology of the power system being altered at each of the plurality of times;
solve a plurality of initial value problems with the plurality of power system component vectors for a time step using the simulation in parallel;
obtain a plurality of post-event equilibrium points corresponding to the plurality of solved initial value problems;
obtain a system matrix based on the plurality of post-event equilibrium points;
identify an earliest instability event and an instability time corresponding to the earliest instability event in the power system by decomposing the system matrix;
identify one or more original machines participating in the earliest instability event at the instability time based on participation factors; and
schedule a pre-determined protection action to the one or more original machines in the power system at the instability time.

13. The system of claim 12, wherein the simulation uses a variable-step backward Euler method.

14. The system of claim 13, wherein the variable-step backward Euler method determines the time step based on a hyperparameter to be tuned and a first mismatch vector.

15. The system of claim 12, wherein each of the plurality of power system component vectors comprises a device state vector for a plurality of devices in the power system and a bus voltage vector for a plurality of bus voltages in the power system.

16. The system of claim 12, wherein the topology of the power system is altered in at least one of: an unstable local voltage, an unstable frequency, an unstable non-oscillatory angle, or an unstable local oscillatory angle.

17. The system of claim 12, wherein the plurality of power system component vectors are obtained in series.

18. The system of claim 12, wherein the system matrix is calculated further based on a byproduct of a Jacobian matrix.

19. The system of claim 12, wherein the system matrix is calculated by:
$$A = {P}_{11} + {P}_{12} {P}_{22}^{- 1} {P}_{21} ,$$
where A is the system matrix,
$${P}_{11} = \frac{1}{Δ t} ( I - {J}_{11} ) , {P}_{12} = - \frac{1}{Δ t} ( {J}_{12} ) , {P}_{12} = - \frac{1}{Δ t} ( {J}_{12} ) , {P}_{21} = - {J}_{21} ,$$
$${P}_{22} = {J}_{22} , where {J}_{11} = \frac{\partial F}{\partial {x}_{n + 1}} , {J}_{12} = \frac{\partial F}{\partial {V}_{n + 1}} , {J}_{21} = \frac{\partial G}{\partial {x}_{n + 1}} , {J}_{22} = \frac{\partial G}{\partial {V}_{n + 1}} ,$$
$$F ( {x}_{n} + 1 , {V}_{n + 1} ) = 0 , G ( {x}_{n + 1} , {V}_{n + 1} ) = 0 ,$$
I is an identity matrix, and Δt is the time step.

20. The system of claim 12, wherein the decomposing the system matrix comprises decomposing the system matrix into an eigen vector and an eigenvalue.

21. The system of claim 12, wherein the one or more original machines are identified further based on a modeshape.

22. The system of claim 12, further comprising:
rerunning the simulation with a reinitiated power system component vector at the instability time and the pre-determined protection action.
